(19) United States
(12) Patent Application Publication
(10) Pub. No.: US 2024/0352042 A1
(43) Pub. Date: Oct. 24, 2024

(54) METAL ORGANIC FRAMEWORK FILM AND METHOD OF MAKING

(71) Applicant: UTI Limited Partnership, Calgary (CA)

(72) Inventors: Milana Trifkovic, Calgary (CA); George Kisa Hayashi Shimizu, Calgary (CA); Shuo Lin, Calgary (CA); Stephanie Ann Kedzior, Ottawa (CA)

(73) Assignee: UTI Limited Partnership, Calgary, AB (CA)

(21) Appl. No.: 18/290,692

(22) PCT Filed: Jul. 22, 2022
(86) PCT No.: PCT/CA2022/051141

§ 371 Date: Jan. 19, 2024

Related U.S. Application Data
(60) Provisional application No. 63/224,672, filed on Jul. 22, 2021.

(51) Int. Cl. C07F 1/08; C08L 1/02; C08L 5/04; C08L 5/08

(52) U.S. Cl. CPC C07F 1/08; C08L 1/02; C08L 5/04; C08L 5/08

(57) ABSTRACT

An MOF film comprising an MOF and an organic scaffold. The MOF is attached to the organic scaffold by hydrogen bonds. The MOF film may be a PCMOF and/or HKUST and may have proton conductive properties. The MOF film may comprise a coordinated metal. The organic scaffold may comprise cellulose material. The MOF film may be free standing without physical support from another material or structure, may be formed into shapes, and may be bent or folded. The MOF film may comprise an MOF and an organic scaffold at different weight ratios.

### CROSS-REFERENCE TO RELATED APPLICATIONS

This application claims the benefit of the filing of U.S. Provisional Patent Application No. 63/224,672, entitled “Metal Organic Framework Film and Method of Making”, filed on Jul. 22, 2021, and the specification and drawings thereof are incorporated herein by reference.

### BACKGROUND OF THE INVENTION

### Field of the Invention (Technical Field)

Embodiments of the present invention relate to a proton-conducting metal-organic framework (“MOF”) with an organic scaffold.

### DESCRIPTION OF RELATED ART

Proton conductive materials as the core component, e.g. the solid-state electrolyte, in proton exchange membrane fuel cells have attracted massive industry and research interests due to the world's urgent demand toward alternative, eco-friendly, and sustainable energy technologies. Generally, proton conductive materials are equipped with abundant acidic groups and hydrogen-bond networks, which can work as proton carriers, and provide conducting pathways for the proton, present as hydronium, H₃O⁺, transportation through the solid-state electrolyte. Recently, polymer electrolyte membranes such as Nafion and sulfonated polyether-ether ketones (“SPEEK”) with considerable proton conductivities, i.e. larger than 10⁻² S cm⁻¹, have been widely used in fuel cells. However, these polymeric materials have suffered from several fatal weaknesses, including degradation and breakage at high operational temperature with humidification. Unfortunately, the moist and high-temperature conditions (T>80° C.) are necessary for the diffusion of proton and Pt-based catalytic reaction in hydrous fuel cells, respectively. Thus, designing and exploiting alternative proton conductive materials with not only sufficient thermal stability and stability under humid conditions, but also with efficient proton conduction, are of great importance.

MOFs, structured as multi-dimensional networks from the metal ions/clusters bridged by organic ligands, have favorable properties such as high porosity, variable inner pore size and surface, and high thermal and chemical stabilities. Therefore, MOFs have extensive potential applications such as gas sorption and storage, chemical and photochemical catalyses, sensing, pollutant elimination, drug delivery, water harvesting, etc.

Recently, a series of MOF materials, which have regular arrangement of channels or pores, and rich of sulfonic, phosphoric, or carboxylic acid groups, have been reported to exhibit high proton conductivities. Among these proton-conducting MOFs (“PCMOFs”), proton-conducting metal-organic framework 10 (“PCMOF10”) [Mg₂ (H₂O)₄(H₂L)·H₂O], where H₆L is 2,5-dicarboxy-1,4-benzene-diphosphonic acid, is remarkable for its water stability and extremely high proton conductivity (above 10⁻² S·cm⁻¹ at 70° C. and 95% RH). The hydrogen phosphonate and/or phosphonate groups and lattice water located in between the layers of PCMOF10 can form efficient transfer and transport pathways for conducting protons. However, MOFs are formed as crystalline powders in micron and submicron size and are difficult to fabricate into solid-state electrolytes as membranes or films. Hence, two different paths for processing PCMOFs into membranes (films) have been put forward, namely forming nanosheets through single crystal growth, and embedding MOF powders into polymer-based membranes. Single crystal growth is generally time-consuming and highly limited to MOF species, and the resultant nanosheets are usually too thin and have dimensions too small to be used in fuel cells. As for MOF-embedded polymeric membranes, the polymer's amorphous matrices generate proton-insulating gaps, which can prevent proton transfer and transport and lead to dramatic drops in proton conductivities. One option for overcoming these challenges is to use MOFs and a film-forming nanomaterial in combination in order to yield a free-standing film that retains the MOF properties. This invention relates to the use of cellulose nanocrystals (“CNCs”) as a film-forming nanomaterial to form a film with PCMOF properties.

### BRIEF SUMMARY OF EMBODIMENTS OF THE PRESENT INVENTION

Embodiments of the present invention generally relate to a metal-organic framework film comprising: a metal-organic framework; and an organic scaffold; the metal-organic framework attached to the organic scaffold by hydrogen bonds. In one embodiment, the metal-organic framework film further comprises a coordinated metal. In another embodiment, the coordinated metal comprises lanthanum. In another embodiment, the metal organic framework film is proton conductive. In another embodiment, the metal organic framework comprises [Cu₃(BTC)·2(H₂O)₃]ₙ.

In one embodiment, the organic scaffold comprises a cellulose material. In another embodiment, the organic scaffold comprises a cellulose nanocrystal. In another embodiment, the organic scaffold comprises a cellulose nanofibril. In another embodiment, the organic scaffold comprises chitosan. In another embodiment, the organic scaffold comprises alginate. In another embodiment, the organic scaffold comprises hyaluronic acid.

In one embodiment, a ratio of the metal-organic framework and the organic scaffold is about 10:1. In another embodiment, a ratio of the metal-organic framework and the organic scaffold is about 8:1. In another embodiment, a ratio of the metal-organic framework and the organic scaffold is about 6:1. In another embodiment, a ratio of the metal-organic framework and the organic scaffold is about 4:1. In another embodiment, a ratio of the metal-organic framework and the organic scaffold is about 2:1.

Embodiments of the present invention also relate to a method of making a metal-organic framework film, the method comprising: contacting a metal with a hydrogen lattice to form a mixture; heating the mixture under pressure; cooling the mixture to produce crystals; contacting the mixture with an organic scaffold to form a crystal and organic scaffold mixture; at least partially disposing the crystal and organic scaffold mixture into a cast; and drying the crystal and organic scaffold mixture. In another embodiment, the mixture is cooled at ambient temperature. In another embodiment, the organic scaffold comprises cellulose nanocrystals. In another embodiment, the metal comprises magnesium.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a field-emission scanning electron microscope (“FE-SEM”) image of a PCMOF&CNC film and graphic showing the material surface interaction between the PCMOF10 and CNC film;

FIGS. 2A and 2B are a photograph of proton-conducting metal-organic framework and cellulose nanocrystals (“PCMOF&CNC”) films with varying PCMOF:CNC ratios and graphics showing the chemical structure of PCMOF10, the chemical structure of CNC, the general spatial interaction of PCMOF10 and CNCs in PCMOF&CNC film, and the material surface interaction between the PCMOF10 and CNC;

FIG. 3 is a graphic comparing the different scales of PCMOF&CNC components;

FIG. 4 is a graphic showing the optimized geometry for an assembly of a cleaved CNC surface with a cleaved PCMOF10 crystal surface;

FIG. 5 is a graphic showing a PCMOF&CNC film with hydrogen bond in the optimized geometric structure, with blue dash lines representing intermolecular hydrogen bonds between the MOF crystal surface and CNC surface and red dash lines representing intramolecular hydrogen bonds among the CNC;

FIGS. 6A to 6F are a series of FE-SEM images of PCMOF10, MOF films with varying PCMOF:CNC ratios, and CNC film;

FIG. 7 is a graph of X-ray detection (“XRD”) patterns for simulated PCMOF10, and for as-synthesized and post-impedance PCMOF&CNC films with varying PCMOF:CNC ratios;

FIGS. 8(a) to 8(f) are Nyquist plots for PCMOF&CNC films with varying PCMOF:CNC ratios and for CNC film at 95% relative humidity;

FIG. 9 is a graph of the log of conductivity as a function of inverse temperature for repeated heating and cooling cycles of PCMOF10, PCMOF&CNC films with varying PCMOF:CNC ratios, and CNC film;

FIG. 10 is a graph comparing the proton conductivities of PCMOF10, PMMOF&CNC-8/1, and CNC film to MOFs and covalent organic frameworks (“COFs”) in membrane shape-bodies;

FIG. 11 is a graph showing the Fourier transform infrared spectroscopy (“FTIR”) from 4000 to 1950 cm⁻¹ of PCMOF10, PCMOF&CNC films with varying PCMOF:CNC ratios, and CNC film;

FIG. 12 is a table showing the weight ratios of PCMOF10 to CNC, the film thickness of PCMOF&CNC film for a given weight ratio, and photographs of synthesized PCMOF&CNC films at varying PCMOF:CNC ratios;

FIGS. 13A to 13F are a series of FE-SEM images of PCMOF10, PCMOF&CNC-8/1, PCMOF&CNC-6/1, PCMOF&CNC-4/1, PCMOF&CNC-2/1, and CNC film;

FIG. 14 is a graph of the thermogravimetric analysis (“TGA”) and differential scanning calorimetry (“DSC”) for PCMOF10;

FIG. 15 is a graph of the TGA and DSC for PCMOF&CNC-8/1;

FIG. 16 is a graph of the TGA and DSC for PCMOF&CNC-6/1;

FIG. 17 is a graph of the TGA and DSC for PCMOF&CNC-4/1;

FIG. 18 is a graph of the TGA and DSC for PCMOF&CNC-2/1;

FIG. 19 is a graph of the TGA and DSC for CNC;

FIGS. 20A to 20C are Nyquist plots for PCMOF10 with 95% relative humidity (“RH”) for a first heating cycle, a first cooling cycle, and a second heating cycle;

FIGS. 21A to 21C are Nyquist plots for PCMOF&CNC-8/1 with 95% RH for a first heating cycle, a first cooling cycle, and a second heating cycle;

FIGS. 22A to 22C are Nyquist plots for PCMOF&CNC-6/1 with 95% RH for a first heating cycle, a first cooling cycle, and a second heating cycle;

FIGS. 23A to 23C are Nyquist plots for PCMOF&CNC-4/1 with 95% RH for a first heating cycle, a first cooling cycle, and a second heating cycle;

FIGS. 24A to 24C are Nyquist plots for PCMOF&CNC-2/1 with 95% RH for a first heating cycle, a first cooling cycle, and a second heating cycle;

FIGS. 25A to 25C are Nyquist plots for CNC film with 95% RH for a first heating cycle, a first cooling cycle, and a second heating cycle;

FIG. 26 is a table comparing the proton conductivities and activation energies of PCMOF10, PCMOF&CNC films with varying PCMOF:CNC ratios and CNC films to various proton-conductive materials;

FIG. 27 is a graph showing conductivity verses relative humidity for PCMOF10, PCMOF&CNC films with varying PCMOF:CNC ratios and CNC films at 25° C.;

FIGS. 28A to 28D are Nyquist plots for PCMOF10 at 25° C. under varying humidities;

FIGS. 29A to 29D are Nyquist plots for PCMOF&CNC-8/1 at 25° C. under varying humidities;

FIGS. 30A to 30D are Nyquist plots for PCMOF&CNC-6/1 at 25° C. under varying humidities;

FIGS. 31A to 31D are Nyquist plots for PCMOF&CNC-4/1 at 25° C. under varying humidities;

FIGS. 32A to 32D are Nyquist plots for PCMOF&CNC-2/1 at 25° C. under varying humidities;

FIGS. 33A to 33D are Nyquist plots for CNC film at 25° C. under varying humidities;

FIGS. 34A to 34F are Arrhenius plots for PCMOF10, PCMOF&CNC films with varying PCMOF:CNC ratios and CNC films between 25-85° C. at 95% RH;

FIG. 35 is a table showing the length and angles of the hydrogen bonds in a PCMOF&CNC film with an optimized geometric structure;

FIG. 36 is a table comparing the MOF loading in Hong Kong University of Science and Technology and cellulose nanocrystal (“HKUST&CNC”)-4/1 film, PCMOF&CNC-8/1 film, lanthanum-metal-organic framework (“La-MOF”), and lanthanum-metal-organic framework and cellulose nanofibril (“La-MOF&CNF”) film, and in various reported MOF and polymer composite membranes;

FIG. 37 is a series of photographs of La-MOF and La-MOF&CNF film processed into rectangular and triangular shapes;

FIG. 38 is a graph of XRD patterns for CNF, La-MOF simulation, La-MOF as-synthesis, and La-MOF&CNF film;

FIG. 39 is a graph of the log of conductivity as a function of inverse temperature for repeated cooling cycles of La-MOF and La-MOF&CNF film; and

FIG. 40 is a graph of X-ray detection (“XRD”) patterns for CNC, Hong Kong University of Science and Technology (“HKUST”)-1 simulation, HKUST-1 as-synthesis, HKUST-1 partially hydrolysed phase, and HKUST&CNC-4/1 film.

### DETAILED DESCRIPTION OF THE INVENTION

Embodiments of the present invention are directed to an MOF film comprising an MOF and an organic scaffold. The organic scaffold may comprise cellulose materials. The MOF may be attached to the organic scaffold by hydrogen bonds. In one embodiment, the MOF film comprises a PCMOF and has proton conductive properties. The MOF film is preferably free standing without physical support from another material or structure. The free-standing MOF film preferably maintains its shape at submillimetric thicknesses. The MOF film preferably comprises a PCMOF10 and a CNC and/or may be a PCMOF10&CNC film.

As used herein, compositions and/or compounds of the format COMPOUND NAME ONE&COMPOUND NAME 2-FIRST NUMBER/SECOND NUMBER shall mean in the specification, drawings, and claims that a first compound and a second compound in a composition are at a ratio by weight of the first number and second number, where the first number corresponds to the first compound, and the second number corresponds to the second compound. For example, the term “PCMOF&CNC-8/1” means that the compound PCMOF and CNC are in a composition at a ratio of 8 PCMOF to 1 CNC. Likewise, the HKUST&CNC-4/1 means that the compound HKUST and CNC are in a composition at a ratio of 4 HKUST to 1 CNC.

The organic scaffold preferably acts as support to host the MOF and preserve its properties through interactions of physical entanglement, van der Waals forces, and/or hydrogen bonds, electrostatic and/or coordination bonds between them. The organic scaffold preferably comprises CNCs. The CNCs preferably comprise nano-sized rods. The CNCs are preferably prepared from cellulose source materials. The CNCs' cellulose polymer chains are held together by strong hydrogen bonds.

An MOF film comprising an organic scaffold may have higher mechanical strength and greater thermal and water resistances compared to an MOF film without an organic scaffold. The mechanical strength and thermal and water resistances may be attributed to hydrogen bonds between MOF crystals surfaces and the organic scaffold surfaces. For example, PCMOF&CNC-8/1 may stably conduct protons above 10⁻² S cm⁻¹ (1.44×10⁻² S cm⁻¹) at 85° C. and 95% RH. An MOF film comprising an organic scaffold may also have greater flexibility compared to an MOF film without an organic scaffold. The higher mechanical strength, greater thermal and water resistances, and greater flexibility are beneficial to operate MOF-based devices durably in sophisticated environments.

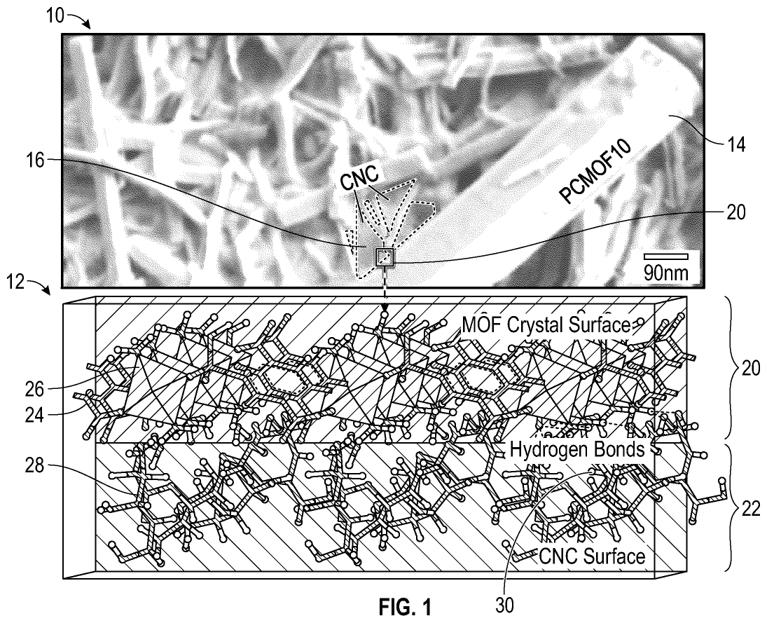

Turning now to the drawings, FIG. 1 shows an FE-SEM image 10 and material interaction 12 between PCMOF10 14 and CNC 16. CNC 16 is aggregated within the interstices of PCMOF10 14. Material interaction 12 shows a surface contact point between CNC 16 and PCMOF10 14 in detail. MOF crystal surface 20 is in contact with CNC surface 22. MOF crystal molecular framework 24 comprising magnesium atoms 26 is bonded to CNC molecular framework 28 by hydrogen bonds 30.

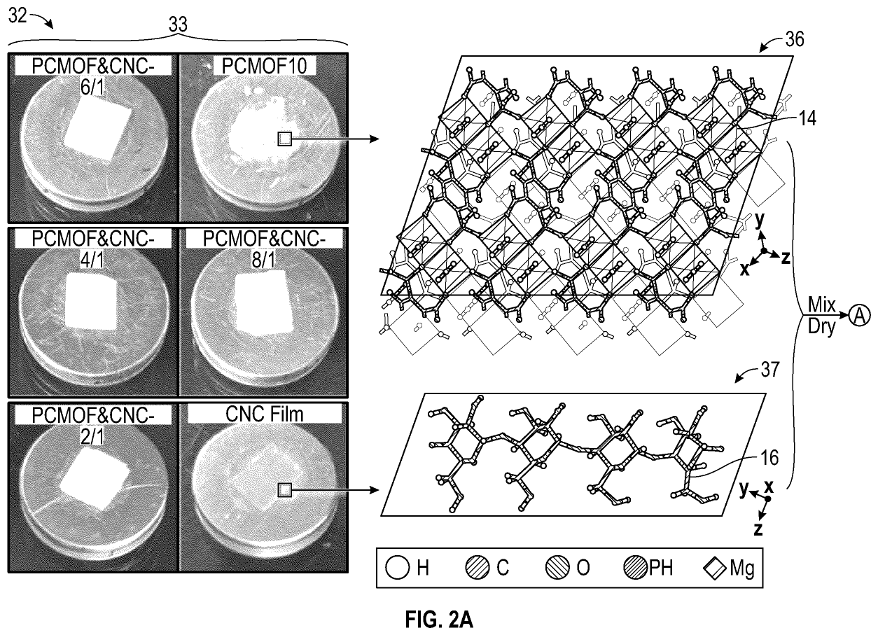

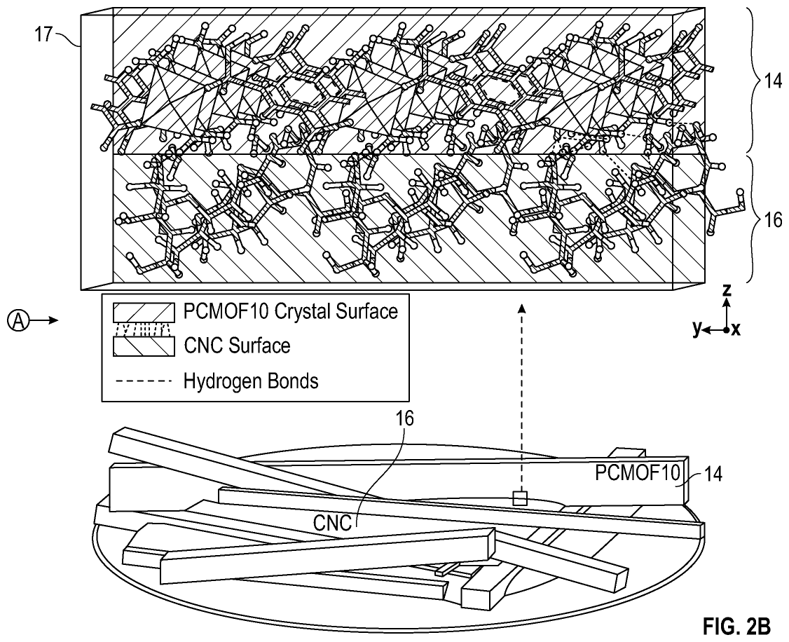

FIGS. 2A to 2B show a flow schematic 32 of how PCMOF10 14 and CNC 16 structurally and chemically interact. Photographs 33 of PCMOF&CNC films with PCMOF:CNC ratios 8/1, 6/1, 4/1, and 2/1, PCMOF10, and CNC film show the PCMOF&CNC films and isolated materials PCMOF10 14 and CNC film 34. The molecular arrangement of PCMOF10 14 alone is depicted in graphic 36 and the molecular arrangement of CNC film 34 is depicted in graphic 37. PCMOF10 14 and CNC 16 are mixed and dried to form material interaction 17, where CNCs 16 are aggregated in the interstitial spaces of PCMOF10 14. The different physical scales for the MOF film components are shown in FIG. 3 by graphic 38.

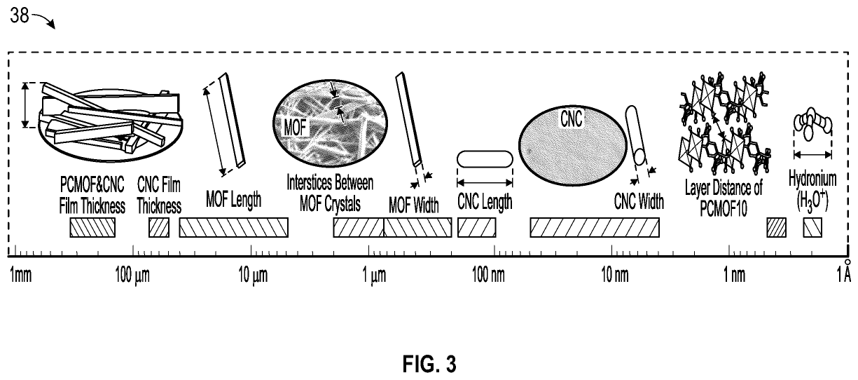

FIG. 4 shows the optimized geometry for an assembly of a cleaved CNC surface with a cleaved PCMOF10 crystal surface as illustrated by graphic 40. MOF crystal surface 20 is bonded to CNC surface 22 by hydrogen bonds with bond lengths of 1.6 Å 42, 1.8 Å 44, 2.2 Å 46, and 1.5 Å 48. MOF crystal molecular framework 24 comprises magnesium atoms 26, hydrogen atoms 50, carbon atoms 52, oxygen atoms 54, and phosphorous atoms 56. CNC molecular framework 28 comprises hydrogen atoms 50, carbon atoms 52, oxygen atoms 54.

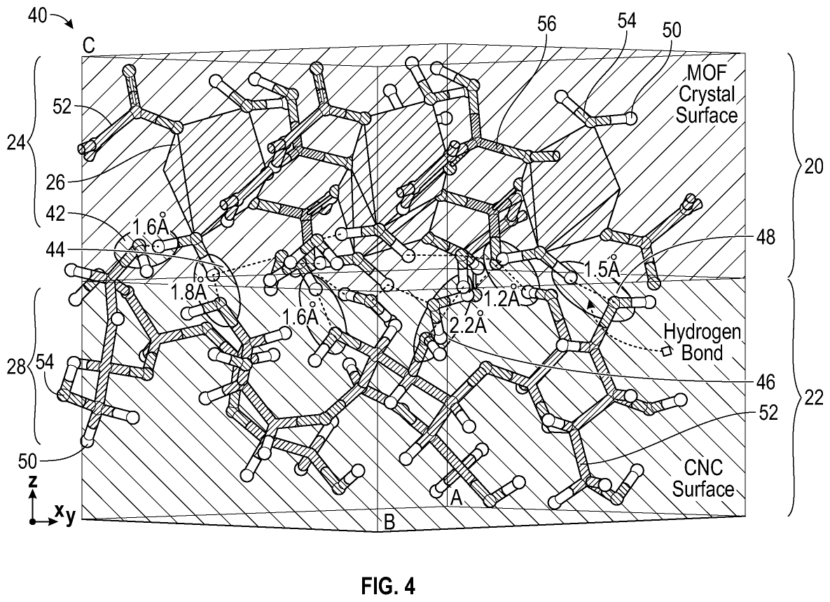

FIG. 5 shows a PCMOF&CNC film with hydrogen bonds in the optimized geometric structure 58. Dashed lines represent intermolecular hydrogen bonds 60 between the MOF crystal surface and CNC surface and broken dashed lines 62 represent intramolecular hydrogen bonds among the CNC.

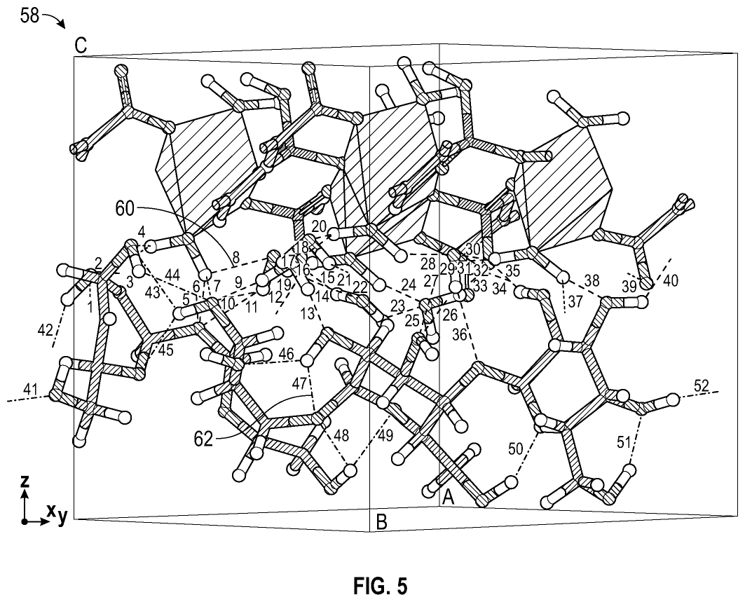

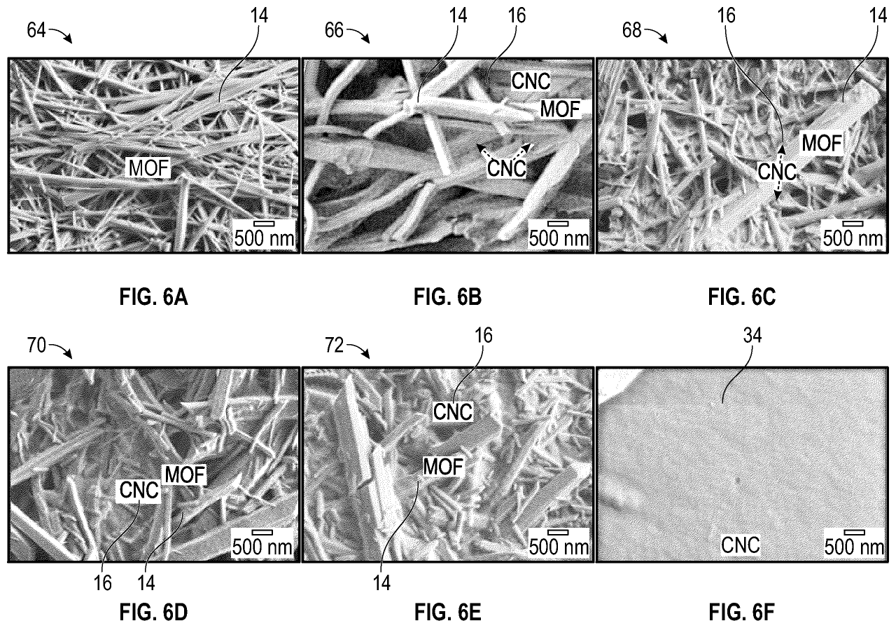

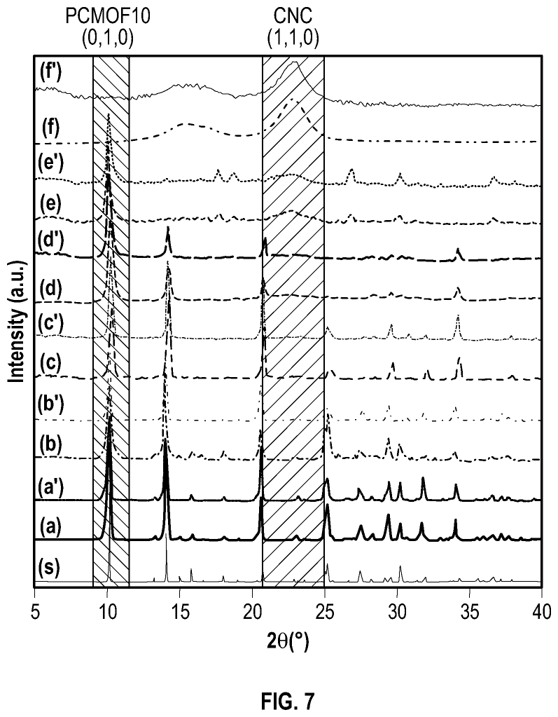

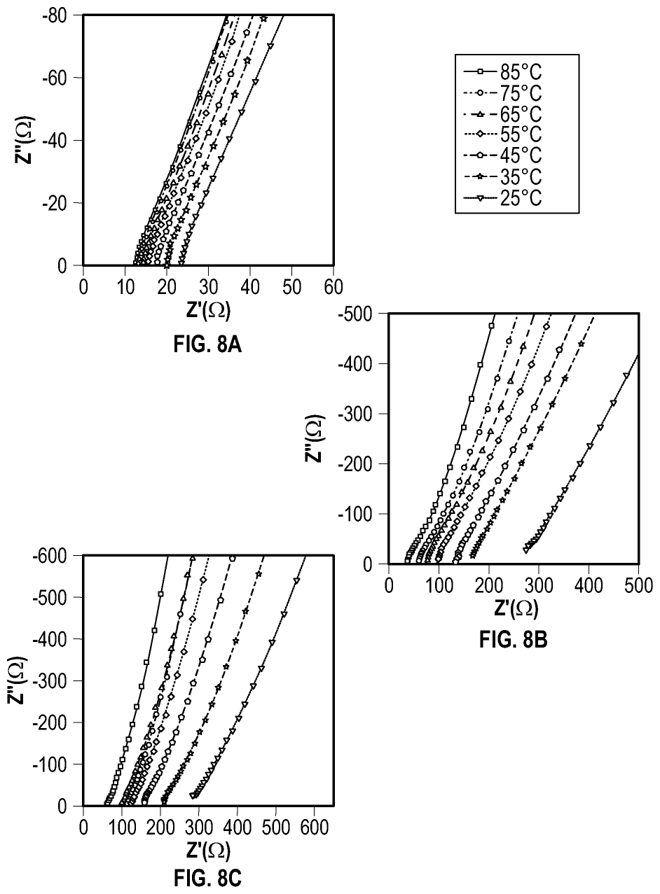

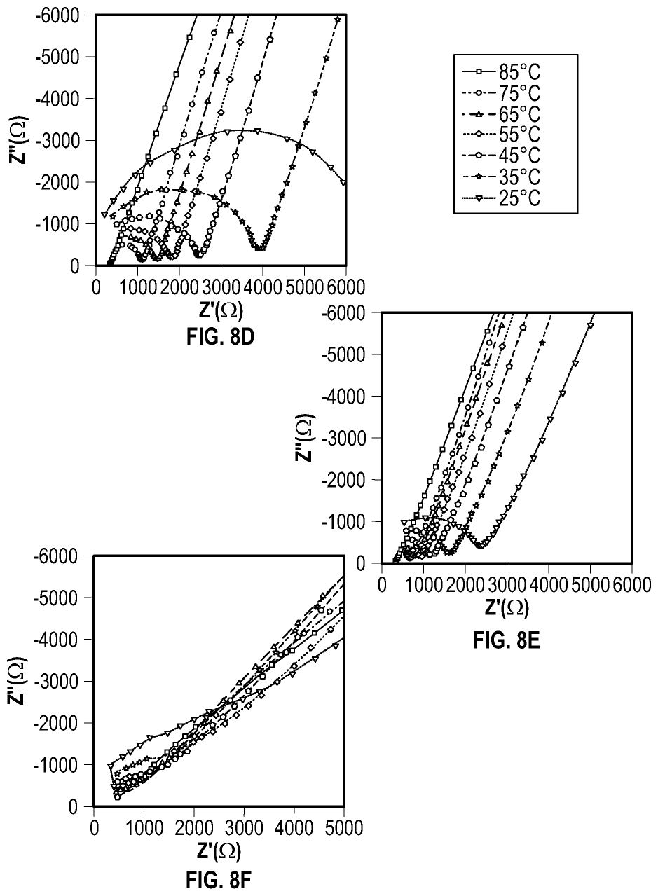

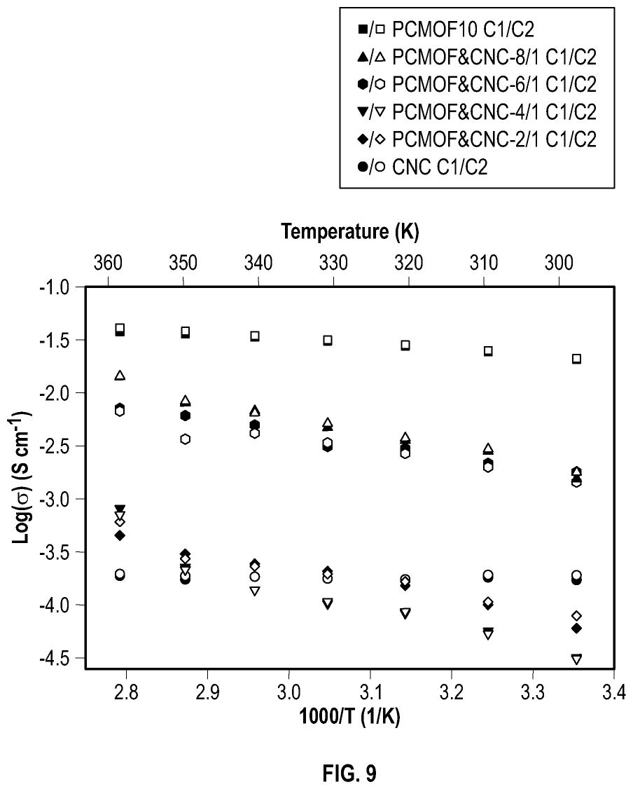

FIGS. 6A to 6F are a series of FE-SEM images 64 of MOF films comprising PCMOF10 14 and CNCs 16, MOF film, and CNC film 34 under high magnification. Specifically, the FE-SEM images are of PCMOF10 14, PCMOF&CNC-8/1 66, PCMOF&CNC-6/168, PCMOF&CNC-4/1 70, PCMOF&CNC-2/1 72, and CNC film 34. XRD patterns for PCMOF10, PCMOF&CNC-8/1, PCMOF&CNC-6/1, PCMOF&CNC-4/1, PCMOF&CNC-2/1, and CNC film were made as-synthesized and post-impedance and are shown in FIG. 7. Nyquist plots for PCMOF10, PCMOF&CNC-8/1. PCMOF&CNC-6/1, PCMOF&CNC-4/1, PCMOF&CNC-2/1, and CNC film, are shown in FIGS. 8A to 8F. The logs of conductivity as a function of inverse temperature for repeated heating and cooling cycles for PCMOF10, PCMOF&CNC-8/1, PCMOF&CNC-6/1, PCMOF&CNC-4/1, PCMOF&CNC-2/1, and CNC film are shown in FIG. 9. FIG. 10 shows a graph comparing the proton conductivities for PCMOF10, PCMOF&CNC-8/1, and CNC film to covalent organic frameworks (“COFs”) in membrane shape-bodies, including a PCMOF-17 single crystal, a CoLa-II single crystal, a Cu-TCPP nanosheet, MOF-801@PP, JUC-200@PVA, MOF 1-PVP, and an aza-COF-2_{H} pellet. The FTIR from 4000 to 1950 cm⁻¹ for PCMOF10, PCMOF&CNC-8/1, PCMOF&CNC-6/1, PCMOF&CNC-4/1, PCMOF&CNC-2/1, and CNC film are shown in FIG. 11.

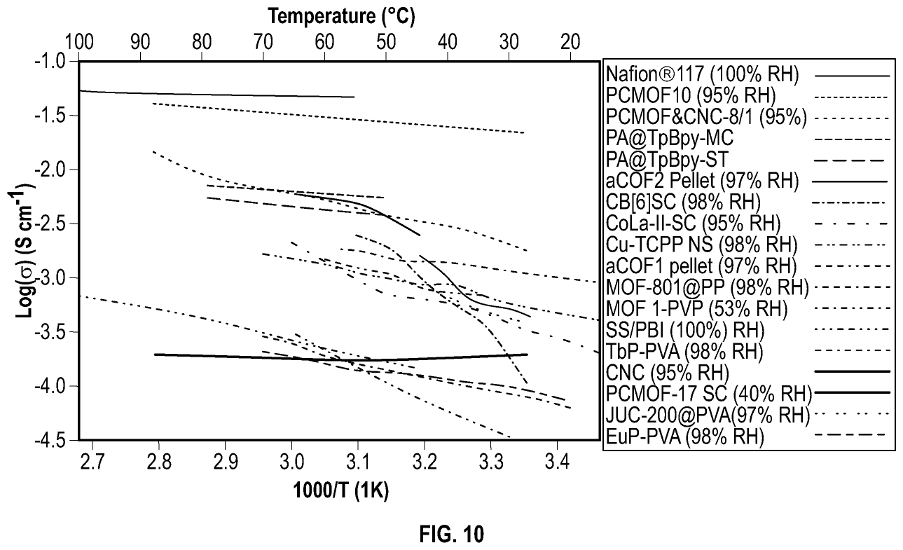

FIG. 12 shows a table listing the weight ratios of PCMOF10 to CNC for PCMOF&CNC-8/1, PCMOF&CNC-6/1, PCMOF&CNC-4/1, PCMOF&CNC-2/1. The film thicknesses for synthesized PCMOF&CNC-8/1, PCMOF&CNC-6/1, PCMOF&CNC-4/1, PCMOF&CNC-2/1 are 0.33 mm, 0.31 mm, 0.16 mm, and 0.14 mm, respectively. The film thickness for CNC is also shown as 0.06 mm.

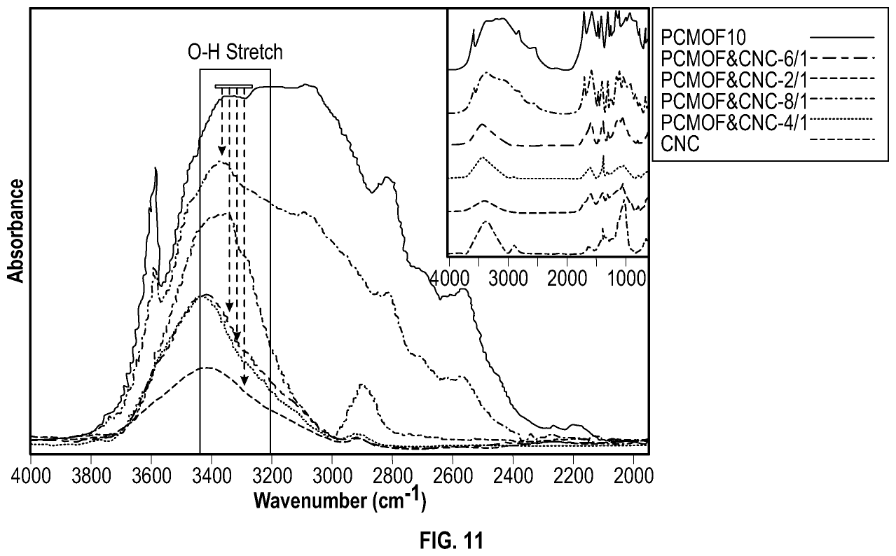

FIGS. 13A to 13F show low-magnification FE-SEM images 74 depicting low-magnification views of PCMOF10 14 embedded into CNCs for films of PCMOF&CNC-8/1 66, PCMOF&CNC-6/1 68, PCMOF&CNC-4/1 70, PCMOF&CNC-2/1 72, and CNC film 34.

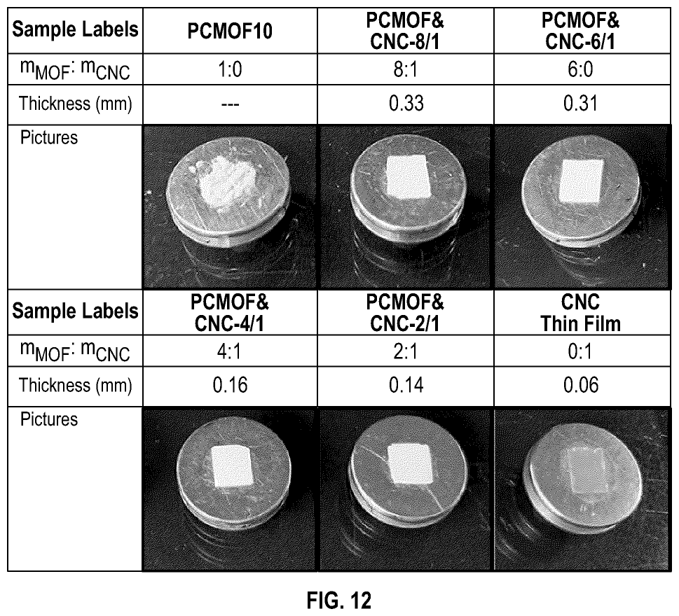

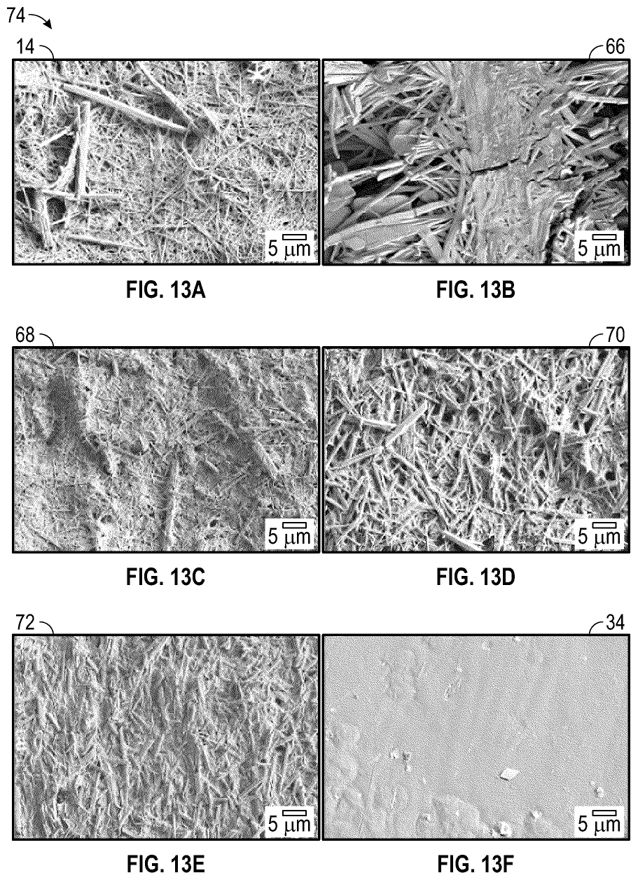

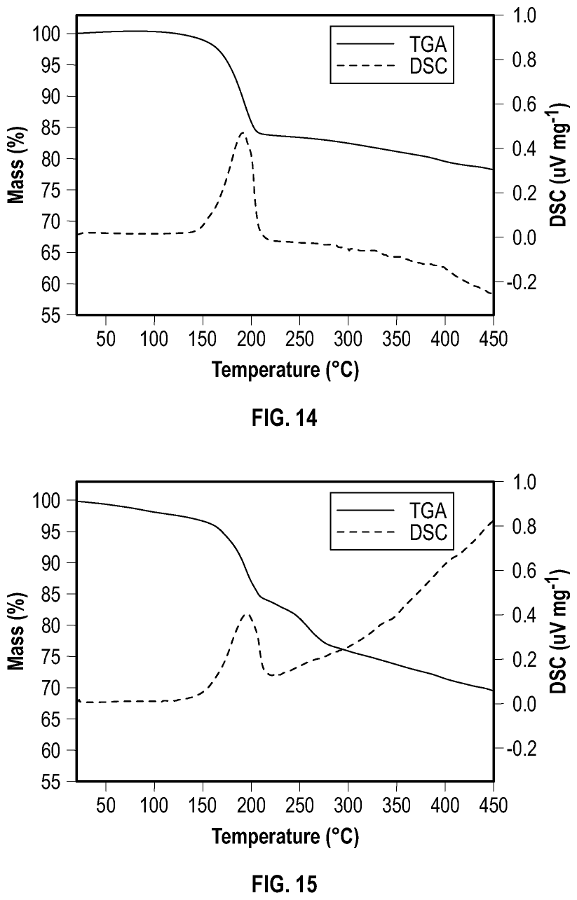

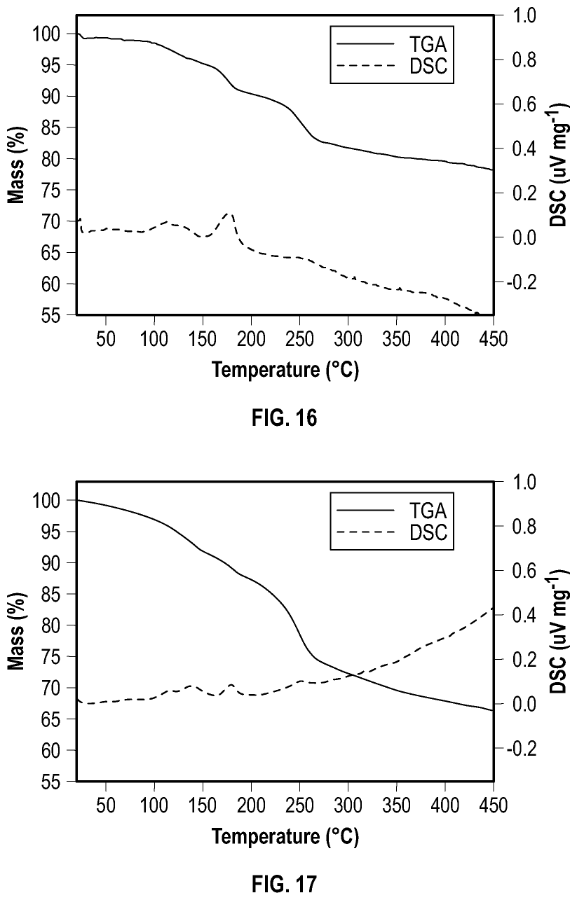

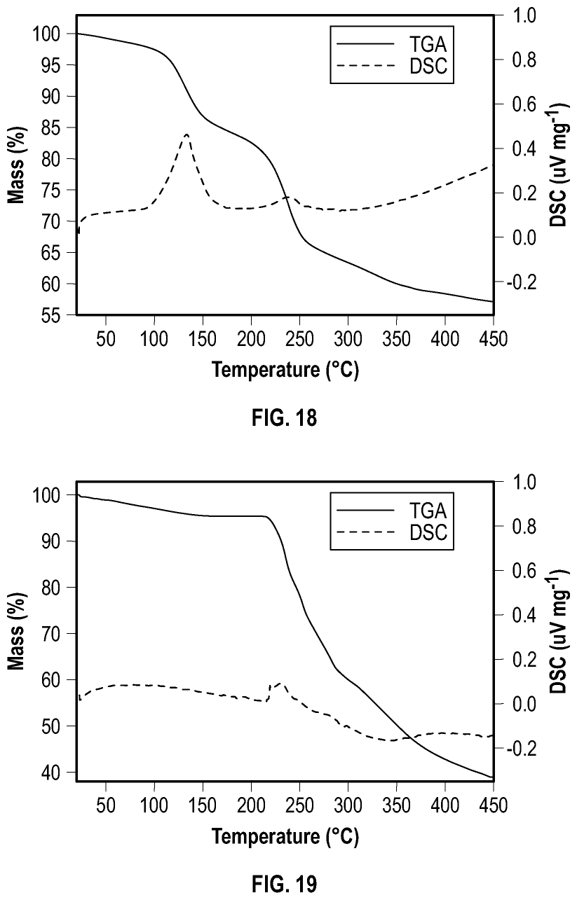

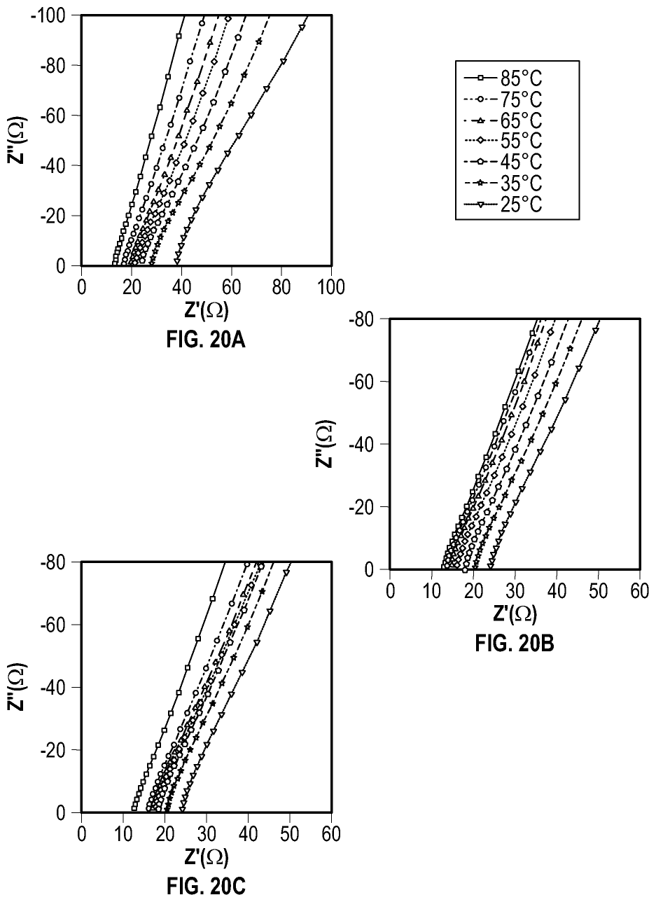

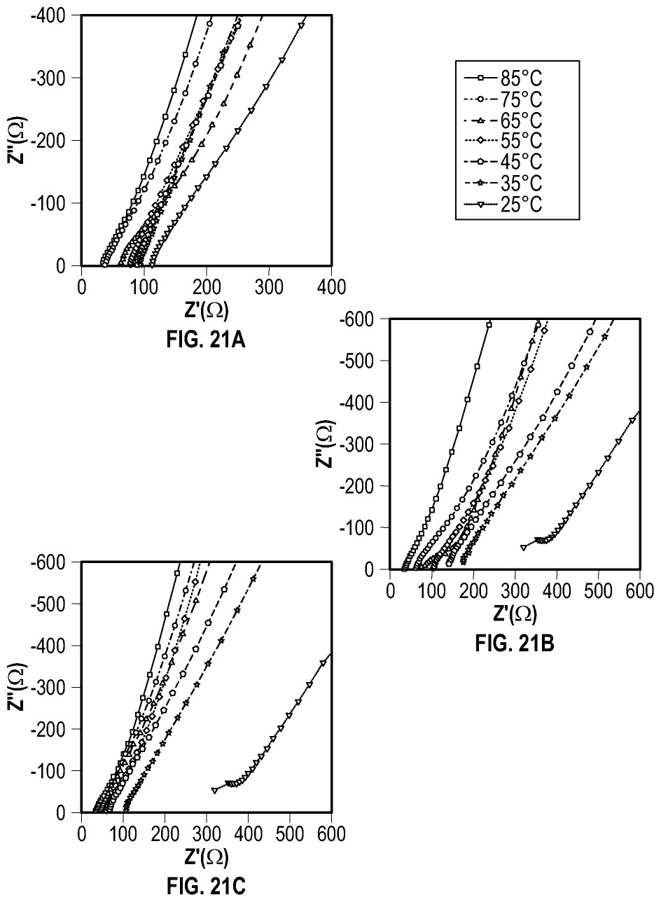

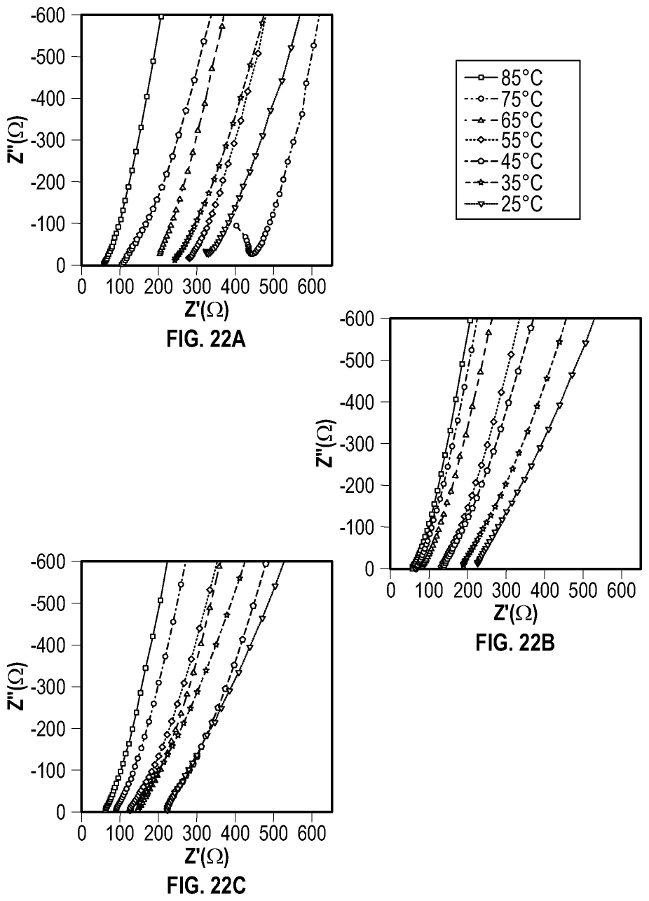

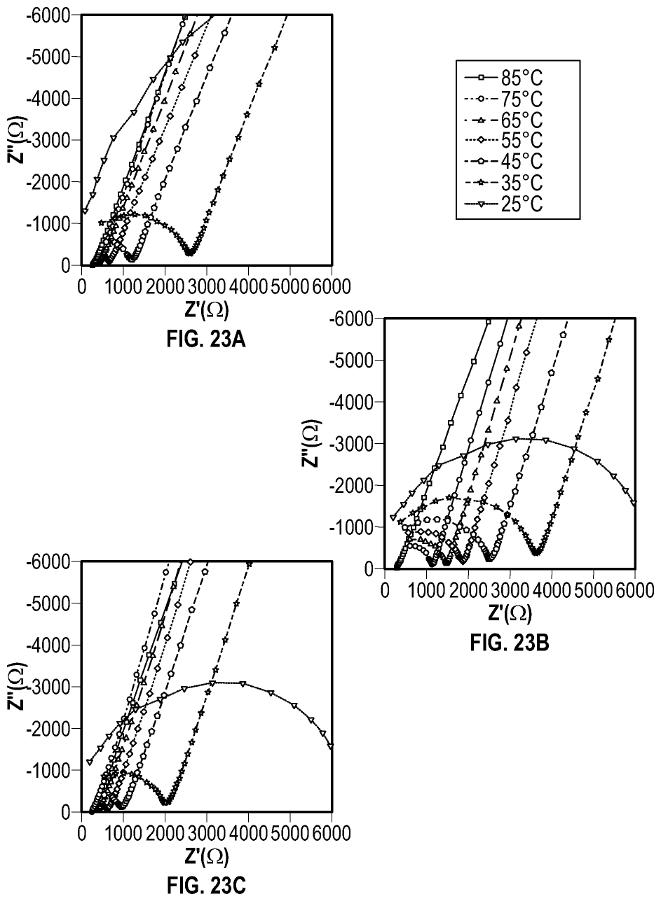

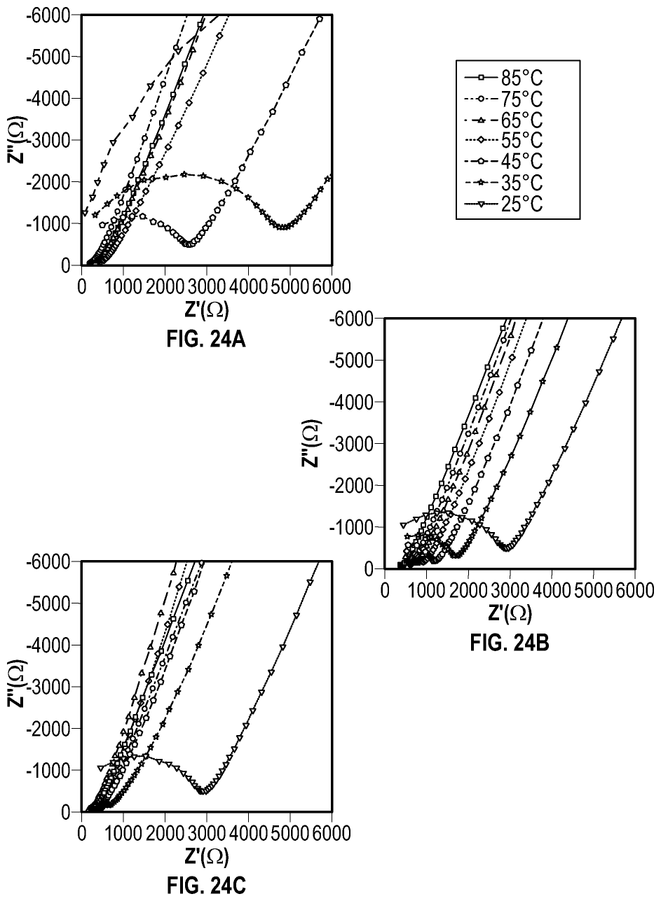

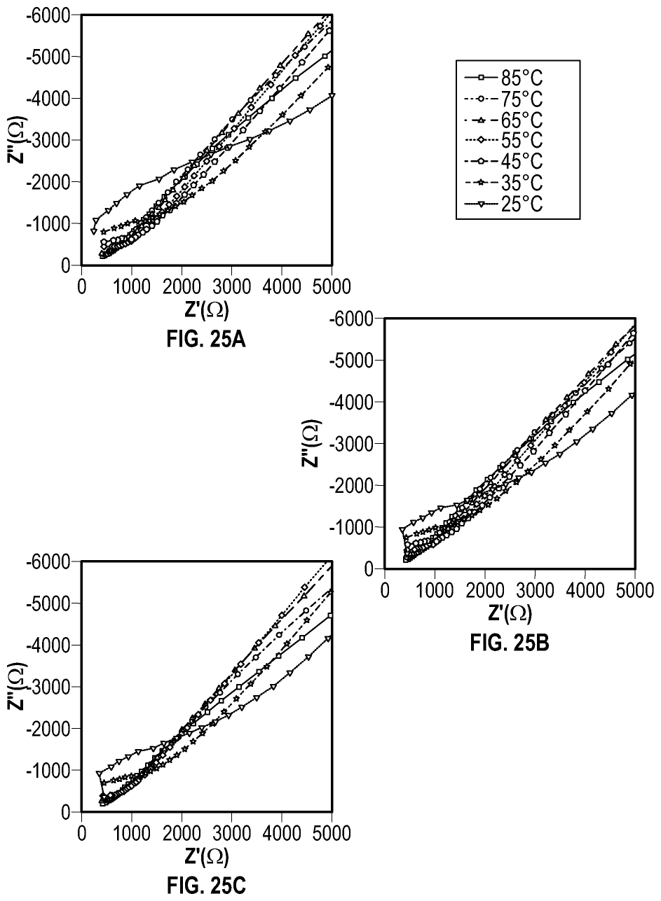

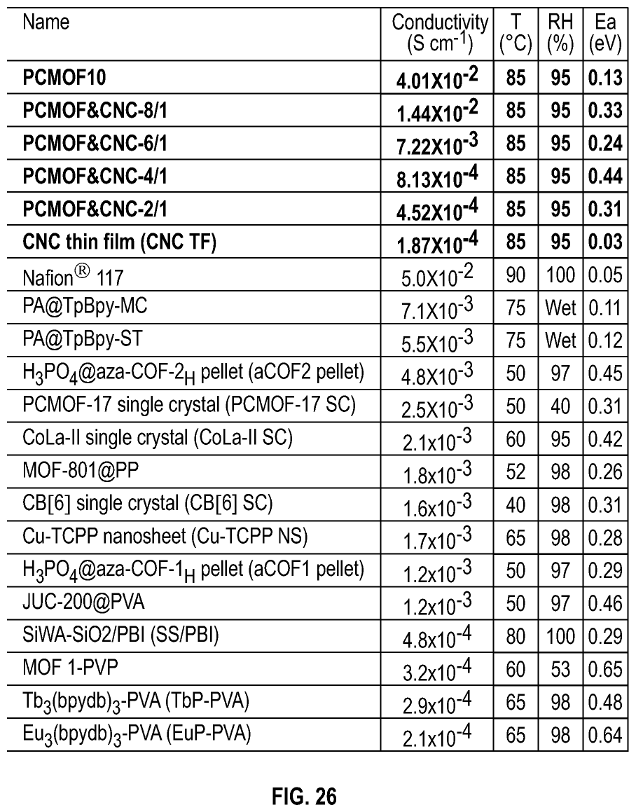

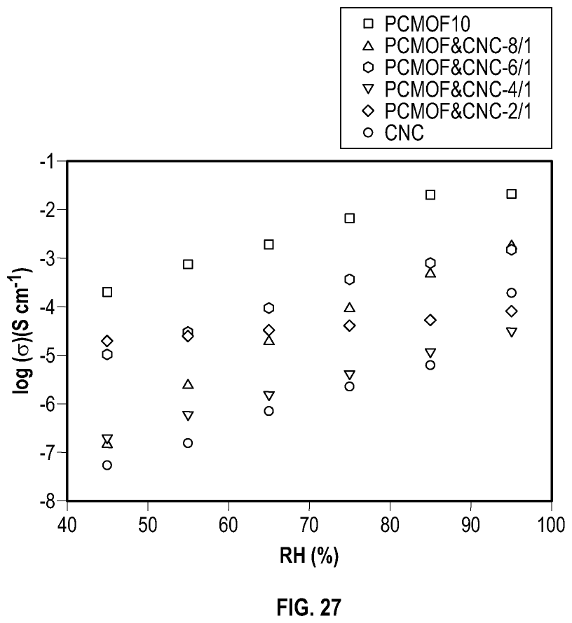

FIGS. 14 to 19 show the TGA and DSC for PCMOF10, PCMOF&CNC-8/1, PCMOF&CNC-6/1, PCMOF&CNC-4/1, PCMOF&CNC-2/1, and CNC film, respectively. FIGS. 20A to 20C to FIGS. 25A to 25C show Nyquist plots at 95% RH for a first heating cycle, a first cooling cycle, and a second heating cycle for PCMOF10, PCMOF&CNC-8/1, PCMOF&CNC-6/1, PCMOF&CNC-4/1, PCMOF&CNC-2/1, and CNC film, respectively. FIG. 26 shows a table comparing the proton conductivities and activation energies of PCMOF10, PCMOF&CNC-8/1, PCMOF&CNC-6/1, PCMOF&CNC-4/1, PCMOF&CNC-2/1, and CNC film to the proton conductivities and activation energies of various other proton conductive materials, including Nafion® 117, SPEEK, PA@TpBpy-MC, PA@TpBpy-ST, H₃PO₄@aza-COF-2_{H} pellet (aCOF2 pellet), PCMOF-17 single crystal (“PCMOF-17 SC”), CoLa-II single crystal (“CoLa-II SC”), MOF-801@PP, CB [6] single crystal (“CB [6] SC”), Cu-TCPP nanosheet (“Cu-TCPP NS”), H₃PO₄@aza-COF-1_{H} pellet (“aCOF1 pellet”), JUC-200@PVA, SiWA-SiO2/PBI (“SS/PBI”), MOF 1-PVP, Tb₃(bpydb)₃-PVA (“TbP-PVA”), and Eu₃(bpydb)₃-PVA (“EuP-PVA”).

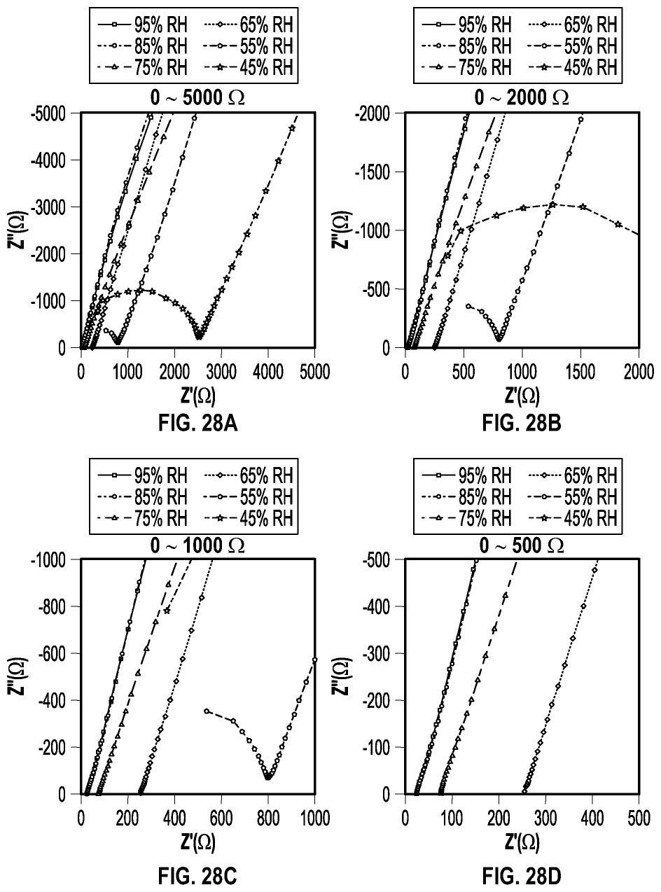

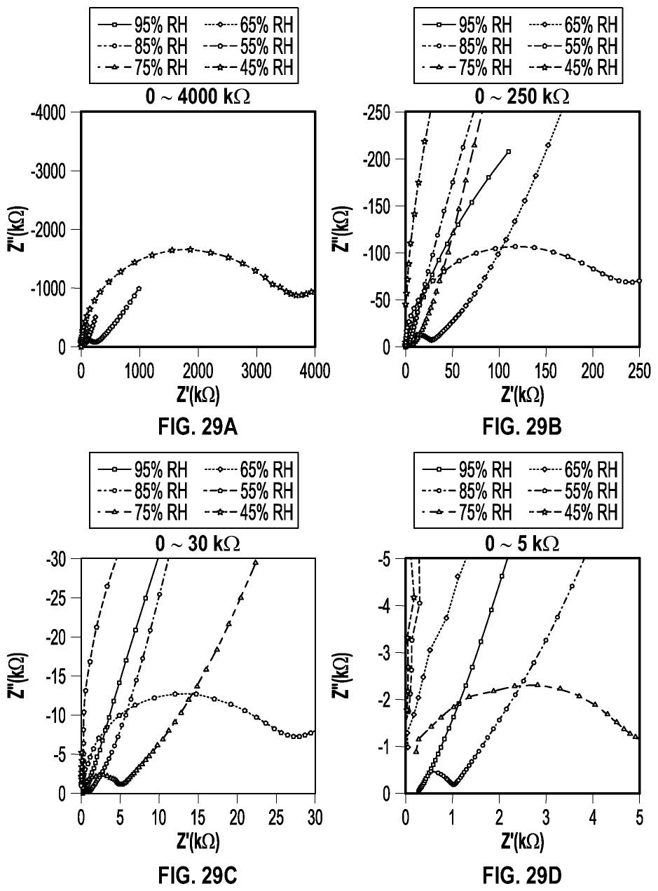

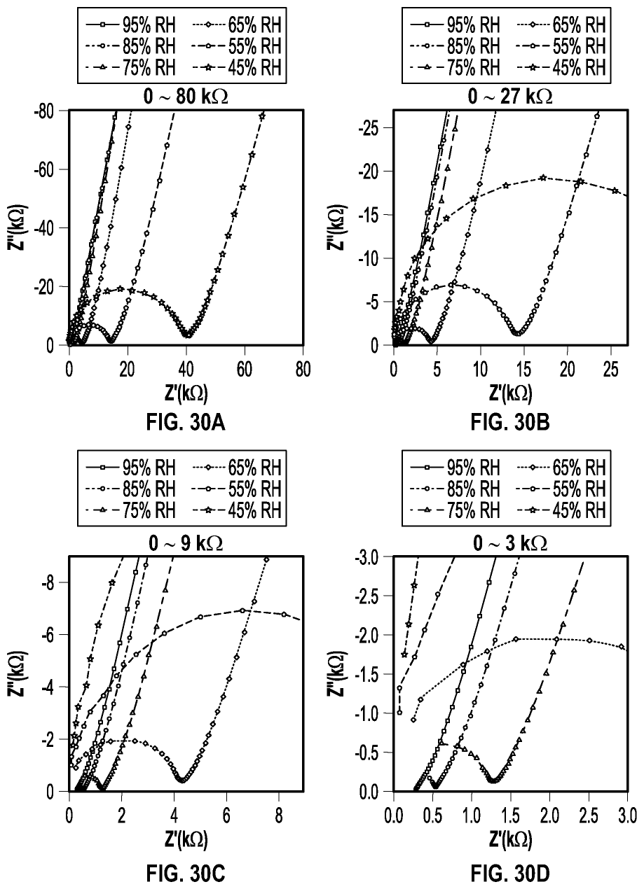

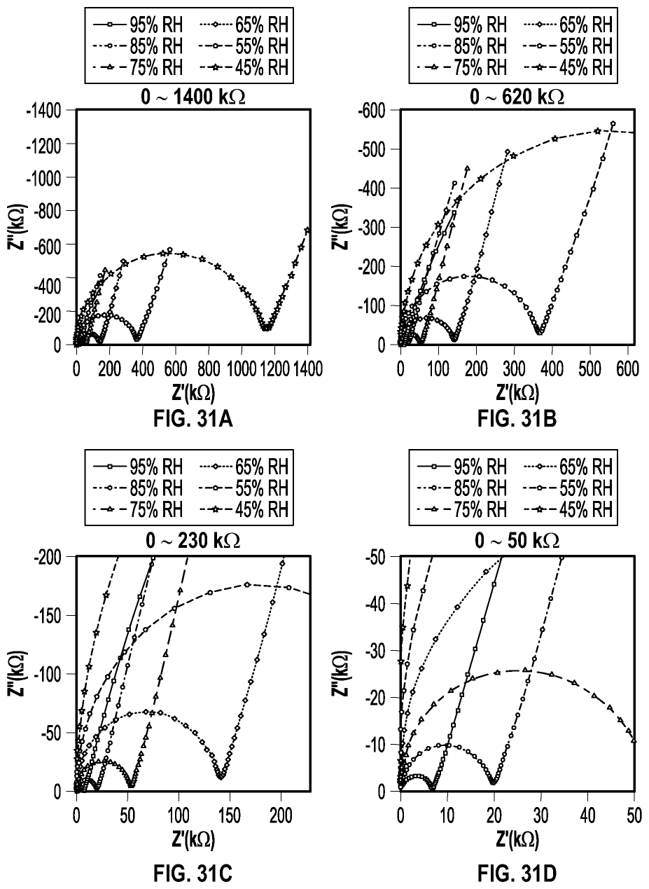

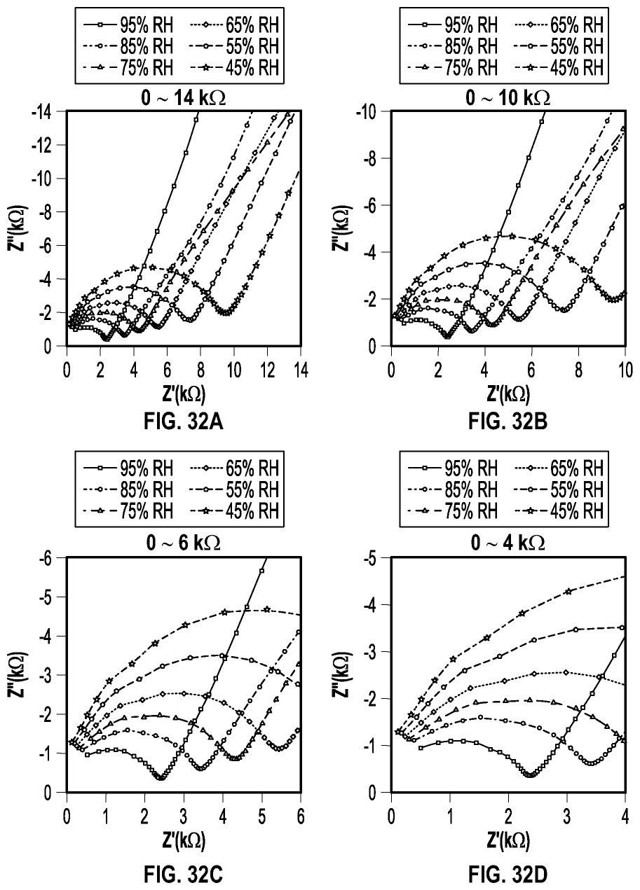

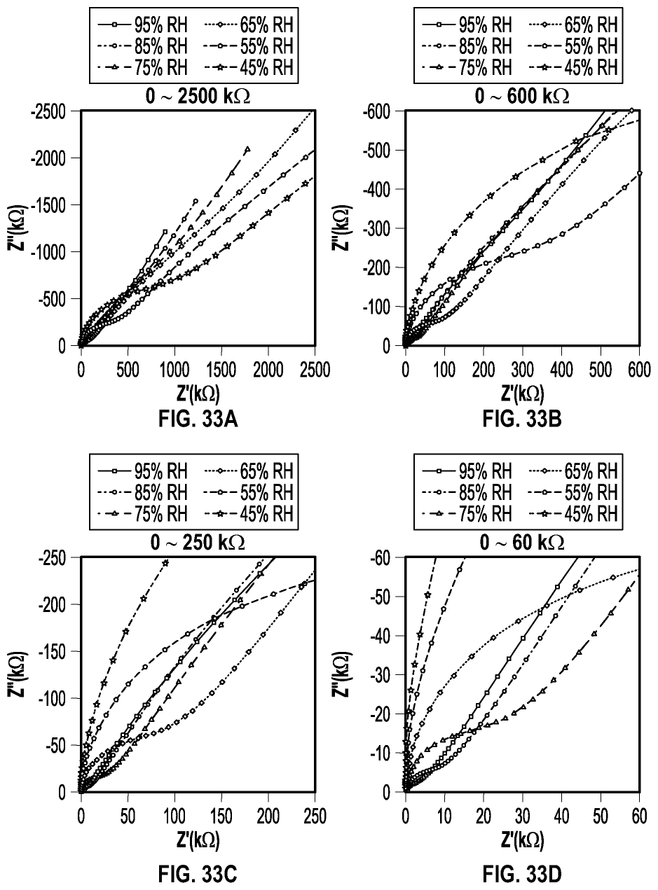

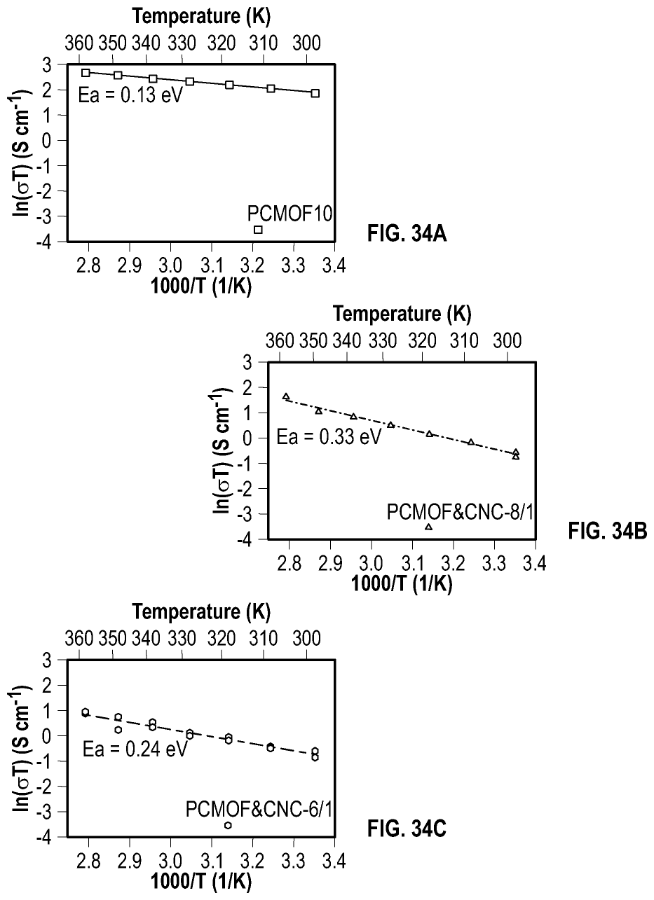

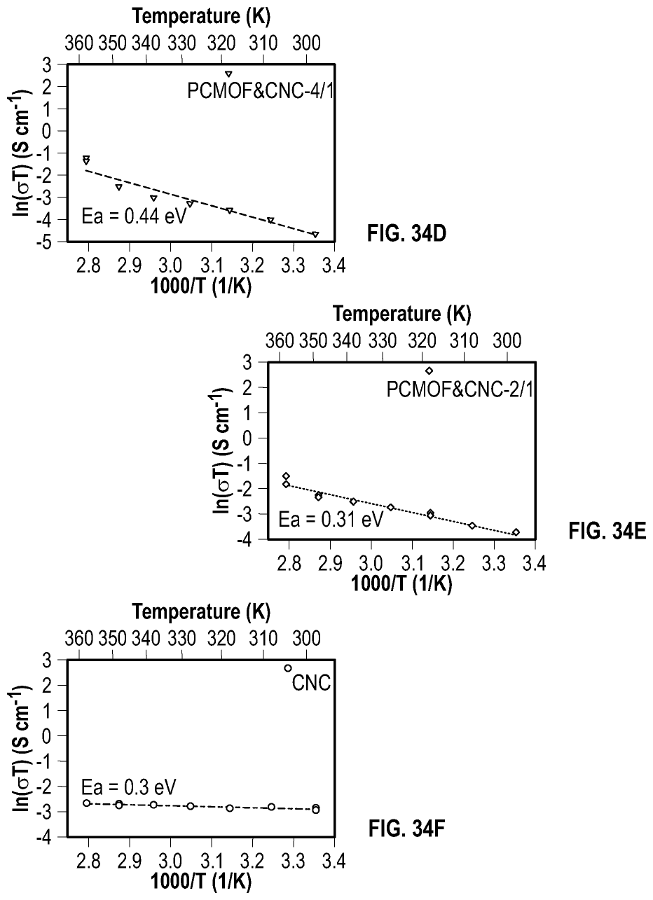

FIG. 27 shows the conductivity verses relative humidity at 25° C. for PCMOF10, PCMOF&CNC-8/1, PCMOF&CNC-6/1, PCMOF&CNC-4/1, PCMOF&CNC-2/1, and CNC film. FIGS. 28A to 28D to FIGS. 33A to 33D show Nyquist plots at 25° C. and 45% RH, 55% RH, 65% RH, 75% RH, 85% RH, and 95% RH for PCMOF10, PCMOF&CNC-8/1, PCMOF&CNC-6/1, PCMOF&CNC-4/1, PCMOF&CNC-2/1, and CNC film respectively. FIGS. 34A to 34F show the Arrhenius plots for PCMOF10, PCMOF&CNC-8/1, PCMOF&CNC-6/1, PCMOF&CNC-4/1, PCMOF&CNC-2/1, and CNC film.

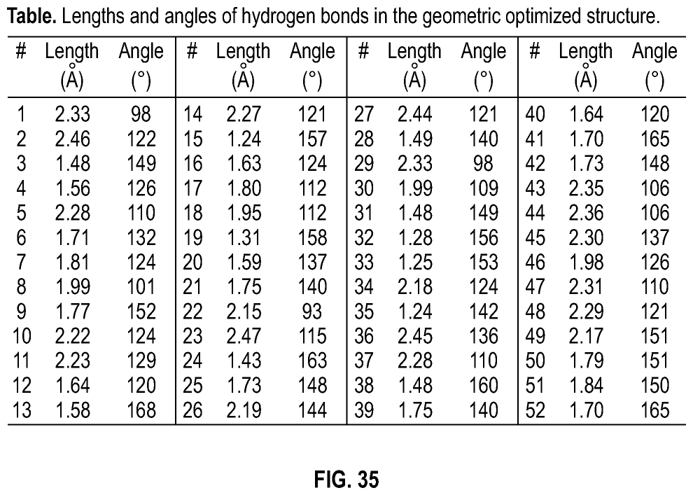

FIG. 35 shows a table listing the length and angles of the hydrogen bonds in a PCMOF&CNC film with an optimized geometric structure shown in FIG. 4.

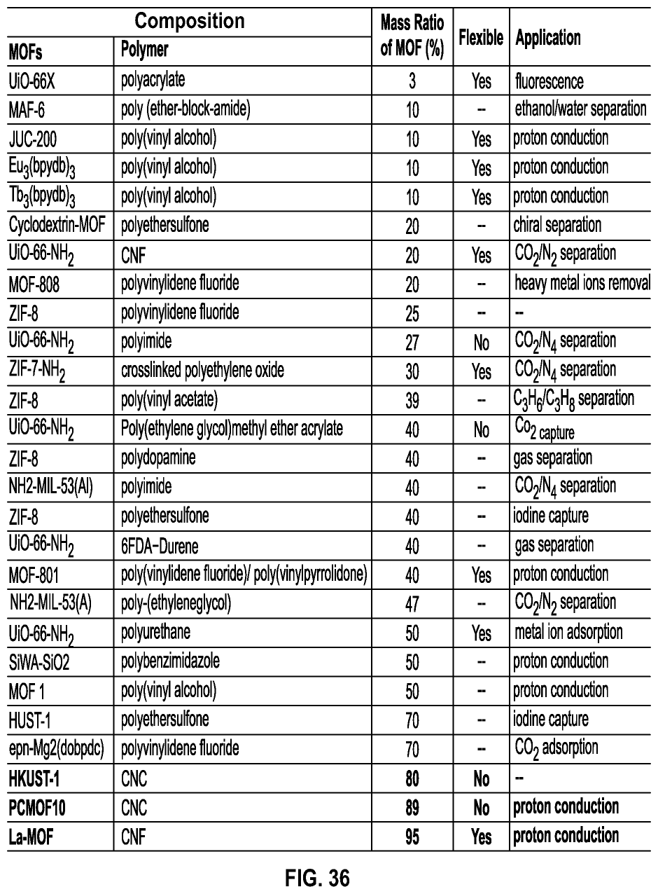

FIG. 36 shows MOF loading with HKUST&CNC-4/1 film, PCMOF&CNC-8/1 film, La-MOF and La-MOF&CNF film compared to various reported MOF and polymer composite membranes. The mass ratio of MOF percentage is greater for the HKUST-1, PCMOF10, and La-MOF films is greater compared to reported MOF and polymer composite membranes.

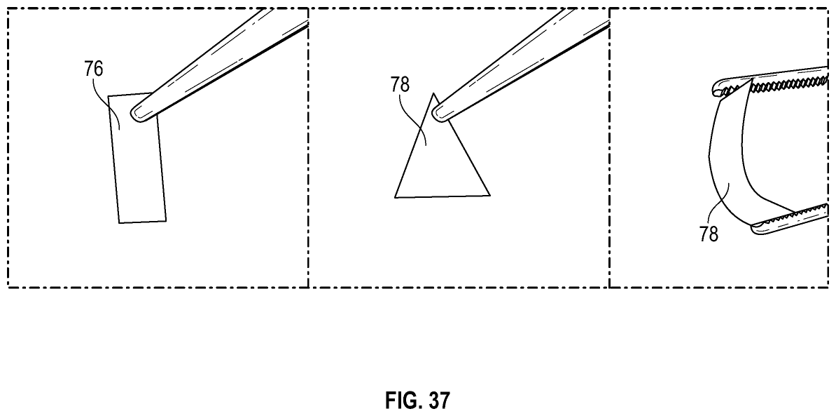

FIG. 37 shows La-MOF films 76 and La-MOF&CNF film 78 processed into rectangular and triangular shapes. La-MOF&CNF film 78 may be flexible and may be bent and/or folded as shown in FIG. 37.

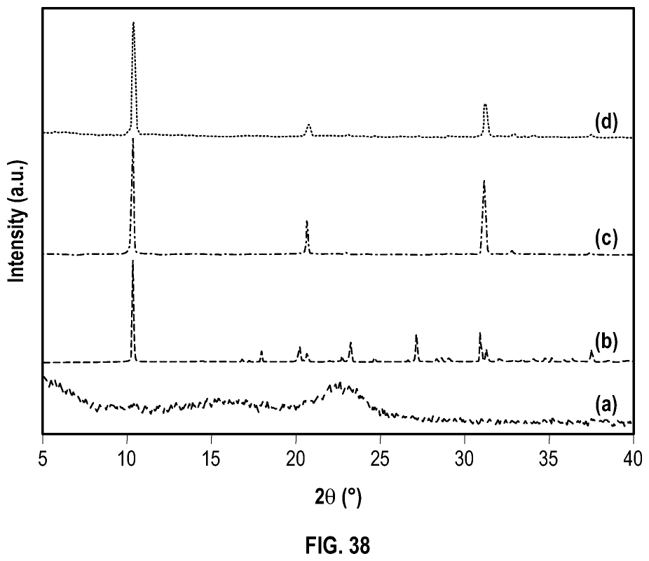

FIG. 38 shows X-ray detection (“XRD”) patterns for CNF, La-MOF simulation, La-MOF as-synthesis, and La-MOF&CNF film as indicated by traces (a), (b), (c), and (d), respectively. The XRD pattern of La-MOF&CNF film is similar to the simulated pattern of La-MOF. The pattern similarity indicates that La-MOF&CNF film retains the crystal structure of pristine La-MOF. The broad reflection centered at 2θ=23° cannot be observed when the CNF content in La-MOF&CNF film is low because of the identical reflection of CNF.

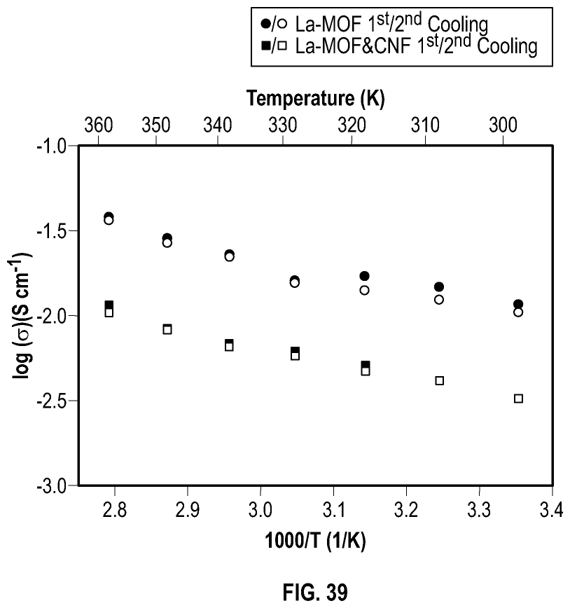

FIG. 39 shows the log of proton conductivity as a function of inverse temperature for repeated cooling cycles (first cooling and second cooling) of La-MOF and La-MOF&CNF film. The proton conductivity of La-MOF at 85° C. and 95% RH is 3.62×10⁻² S cm⁻¹ is shown in graph. The La-MOF&CNF film reserved the high proton conductivity (1.15×10⁻² S cm⁻¹) demonstrated by La-MOF film under the same conditions, e.g., 85° C. and 95% RH is 3.62×10⁻² S cm⁻¹.

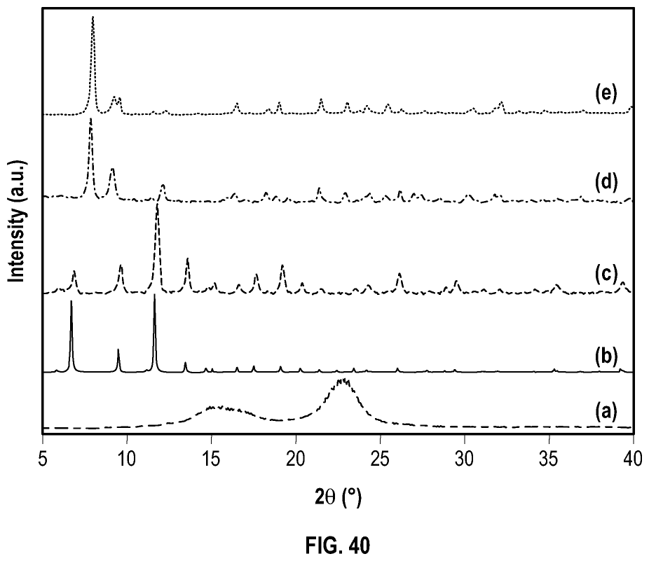

FIG. 40 shows the XRD patterns for CNC, HKUST-1 simulation, HKUST-1 as-synthesis, HKUST-1 partially hydrolysed phase, and HKUST&CNC-4/1 film as indicated by traces (a), (b), (c), (d), and (e) respectively. The pattern of HKUST&CNC-4/1 film is in good agreement with the pattern of HKUST-1 partially hydrolysed phase with high-intensity reflection at 2θ=7°. The high-intensity reflection indicates that HKUST&CNC-4/1 film retains high crystallinity and porosity of pristine HKUST-1 despite the phase conversion after partial hydrolysis. Besides, a low-intensity broad reflection centered at 2θ=23°, attributed to the identical reflection of CNF, can be observed in the pattern of HKUST&CNC-4/1 film.

Embodiments of the present invention are directed to a MOF film comprising a MOF and an organic scaffold. The MOF preferably comprises a PCMOF and has proton or ion conductive properties. In one embodiment, the PCMOF comprises PCMOF10. The MOF may comprise a material that can form a hydrogen bond with CNCs. In another embodiment, the organic scaffold preferably comprises cellulose and/or CNCs. Optionally, the organic scaffold comprises a CNC, CNF, chitosan, alginate, hyaluronic acid, or a combination thereof. The CNF preferably comprises nano-sized fibers and may be prepared from cellulose source materials. The CNF may comprise cellulose polymer chains that may be held together by hydrogen bonds.

The MOF film may comprise different types of MOF including, but not limited to, HKUST. HKUST-1 is a MOF with the formula [Cu₃(BTC)·2(H₂O)₃]ₙ, where BTC is benzene-1,3,5-tricarboxylate, constructed by Cu clusters bridged by BTC ligands. HKUST-1 is one of the most studied MOFs. It is popular for its high porosity and good gas adsorption performance. The MOF film may comprise different HKUST to organic scaffold weight ratios of 8:1, 6:1, 4:1 and 2:1. For example, the MOF film may comprise HKUST&CNC at different ratios including, but not limited to, 8:1, 6:1, 4:1 and 2:1, herein referred to as HKUST&CNC-8/1, HKUST&CNC-6/1, HKUST&CNC-4/1 and HKUST&CNC-2/1, respectively, and each ratio may comprise a different film thickness. The MOF comprising HKUST. For example, a MOF comprising HKUST&CNC-4/1 may comprise a thickness of about 0.11 mm.

The MOF film may comprise a coordinated metal. The coordinated metal includes, but is not limited to, lanthanum (“La”), copper (“Cu”), chromium (Cr), Zinc (“Zn”), magnesium (“Mg”), or a combination thereof. The MOF film may comprise a MOF, a coordinated metal, and an organic scaffold. For example, the MOF film may comprise La-MOF&CNF. The MOF film comprising a coordinated metal may comprise a weight ratio of MOF to organic scaffold of at least about 2:1, about 2:1 to about 20:1, about 4:1 to about 18:1, about 6:1 to about 16:1, about 8:1 to about 14:1, about 10:1 to about 12:1, or about 20:1 The MOF film comprising a coordinated metal may comprise a thickness of at least about 0.1 mm, about 0.1 mm to about 0.5 mm, about 0.15 mm to about 0.45 mm, about 0.2 mm to about 0.4 mm, or about 0.5 mm. The MOF may be an La-MOF and may comprise the formula [La(H₂L)·2H₂O]ₙ, (where H₆L is the organic ligand). The La-MOF may be constructed by La clusters bridged by H₆L ligands. The La-MOF may have high proton conductive performance and/or scalable production.

The MOF film preferably comprises a ratio MOF to organic scaffold. The ratio of MOF to organic scaffold is preferably about 2 to 1 (“2/1”), about 4 to 1 (“4/1”), about 6 to 1 (“6/1”), about 8 to 1 (“8/1”), or about 10 to 1, where ratios are by weight. The total organic scaffold content in the MOF film is preferably at least about 8%, about 8% to about 36%, about 9% to about 33%, about 12% to about 30%, about 15% to about 27%, about 18% to about 33%, or about 36%. The MOF film may comprise different PCMOF10 to CNC weight ratios of 8:1, 6:1, 4:1 and 2:1, herein referred to as PCMOF&CNC-8/1, PCMOF&CNC-6/1, PCMOF&CNC-4/1 and PCMOF&CNC-2/1, respectively.

Embodiments of the present invention also relate to methods for making a MOF film comprising an organic scaffold. The method preferably comprises mixing a metal and a hydrogen lattice and heating the mixture under pressure; cooling the mixture at ambient temperature to produce crystals; mixing the crystals with an organic scaffold in solution; at least partially disposing the crystal and organic scaffold mixture into a cast; and drying the crystal and organic scaffold mixture at ambient temperature. In another embodiment, the metal and hydrogen lattice mixture is preferably mixed with methanol to form a metal, hydrogen lattice, and methanol mixture prior to heating. The crystals preferably comprise PCMOF10. The organic scaffold preferably comprises CNCs. A metal-organic framework cellulose nanocrystal (“MOFCNC”) film is preferably synthesized by ambient drying of a MOF and CNC mixture. Additionally, a PCMOF&CNC film is preferably synthesized by ambient drying of a PCMOF and CNC mixture.

The MOF film is preferably free standing without physical support from another material or structure. A free-standing MOF film preferably maintains its shape at submillimetric thicknesses. The MOF film thickness is preferably at least about 0.06 mm, about 0.06 mm to about 0.50 mm, 0.12 mm to about 0.42 mm, about 0.18 mm to about 0.36 mm, about 0.24 mm to about 0.30 mm, or about 0.50 mm. In some embodiments, the MOF film thickness is about 0.14 mm, about 0.16 mm, about 0.31 mm, or about 0.33 mm. The MOF film is preferably processed into circular, rectangular, or triangular shapes.

The MOF of the MOF film preferably comprises rectangular, cube, stick crystal structures or a combination thereof. The MOF crystals preferably comprise lengths of at least about 5 μm, about 5 μm to about 40 μm, about 10 μm to about 35 μm, about 15 μm to about 30 μm, about 20 μm to about 25 μm, or about 40 μm. The MOF crystals preferably comprise widths of at least about 100 nm, about 100 nm to about 800 nm, about 200 nm to about 700 nm, about 300 nm to about 600 nm, about 400 nm to about 500 nm, or about 800 nm.

Organic scaffolds preferably act as support to host the MOFs and preserve their properties through interactions of physical entanglement, van der Waals force, and/or hydrogen bonds between them. The organic scaffolds preferably comprise rod-like structures. Individual rod-like structures preferably comprise lengths of at least about 100 nm, about 100 nm to about 200 nm, about 110 nm to about 190 nm, about 120 nm to about 180 nm, about 130 nm to about 170 nm, about 140 nm to about 160 nm, or about 200 nm. Individual rod-like like structures preferably comprise widths at least about 4 nm, about 4 nm to about 15 nm, about 5 nm to about 14 nm, about 6 nm to about 13 nm, about 7 nm to about 12 nm, about 8 nm to about 11 nm, about 9 nm to about 10 nm, or about 15 nm. The organic scaffold preferably a CNC. The CNC preferably comprises nano-sized rods. The CNCs are preferably prepared from cellulose source materials. The CNCs' cellulose polymer chains are held together by strong hydrogen bonds.

MOF films comprising an organic scaffold have higher mechanical strength and greater thermal and water resistances compared to MOF films without organic scaffolds. The mechanical strength and thermal and water resistances may be attributed to hydrogen bonds between MOF crystals surfaces and the organic scaffold surfaces. Organic scaffolds preferably aggregate in the interstices of the MOF crystals. MOF films are preferably proton conductive. MOF films preferably comprise proton conductivities of at least about 1.4×10⁻⁷ S cm⁻¹, about 1.4×10⁻⁷ S cm⁻¹ to about 2.0×10⁻³ S cm⁻¹, about 1.0×10⁻⁶ S cm⁻¹ about 1.0×10⁻³ S cm⁻¹, about 1.0×10⁻⁵ S cm⁻¹ to about 1.0×10⁻⁴ S cm⁻¹, or about 2.0×10⁻³ S cm⁻¹. MOF film thickness conductivities preferably are at least about 1.40×10⁻⁷ S cm⁻¹, about 1.40×10⁻⁷ S to about 1.81×10⁻³ S cm⁻¹, about 1.88×10⁻⁷ S cm⁻¹ to about 1.45×10⁻³ S cm⁻¹, about 1.92×10⁻⁵ S cm⁻¹ to about 7.89×10⁻⁵ S cm⁻¹, or about 1.81×10⁻³ S cm⁻¹.

Hydrogen bonds between the MOF and organic scaffold contribute to binding the materials together. The assembly energy of the MOF and organic scaffold surfaces is preferably about 200 kcal mol⁻¹. The hydrogen bond angles are preferably obtuse angles. Additionally, the hydrogen bonds angles preferably comprise lengths of at least about 1.5 Å, about 1.5 Å to about 2.6 Å, about 1.6 Å to about 2.5 Å, about 1.7 Å to about 2.4 Å, about 1.8 Å to about 2.3 Å, about 1.9 Å to about 2.2 Å, about 2.0 Å to about 2.1 Å, or about 2.6 Å.

The MOF and organic scaffold may be attached by hydrogen bonds according to the following bonding patterns:

MOF—P—O - - - HO—R (1)

MOF—P—OH - - - O—R (2)

where dashed lines “- - - ” denote hydrogen bonding between the MOF and organic scaffold. The MOF may be coordinated with a metal and may by attached to the organic scaffold by hydrogen bonds according to the following bonding patterns:

MOF-Metal-OH - - - O—R (3)

MOF-Metal-O - - - HO—R (4)

MOF-Metal-OH₂ - - - O—R (5)

where dashed lines “- - - ” denote hydrogen bonding between the MOF and organic scaffold. The MOF and/or organic scaffold may further comprise a hydroxyl and/or carboxyl group to facilitate hydrogen bonding between the MOF and organic scaffold.

The MOF film is stable under varying temperatures and humidities. MOF film remains stable at temperatures including, but not limited to, about least about 22° C., about 22° C. to about 85° C., about 25° C. to about 80° C., about 30° C. to about 75° C., about 35° C. to about 70° C., about 40° C. to about 65° C., about 45° C. to about 60° C., about 50° C. to about 55° C., or about 85° C. MOF film also remains stable at humidities including, but not limited to, about at least 45% RH, about 45% RH to about 95% RH, about 50% RH to about 90% RH, or about 95% RH.

The present invention also relates to methods for making a MOF film comprising an organic scaffold. Preferably, the method comprises mixing a metal and a hydrogen lattice and heating the mixture under pressure; cooling the mixture at ambient temperature to produce crystals; mixing the crystals with an organic scaffold in solution; at least partially disposing the crystal and organic scaffold mixture into a cast; and drying the crystal and organic scaffold mixture at ambient temperature. The metal and hydrogen lattice mixture may be mixed with methanol to form a metal, hydrogen lattice, and methanol mixture prior to heating. In one embodiment, the metal is a metal compound. The metal compound may comprise a metal including, but not limited to, magnesium, zinc, iron, aluminum, chromium, copper, lanthanides, or a combination thereof. The metal may be in ionic or anionic form. In one embodiment, the metal compound is Mg(NO₃). In one embodiment, the hydrogen lattice comprises H₆L. In one embodiment, the crystals are colorless. In one embodiment, the crystals comprise PCMOF10. In one embodiment, the crystals are washed with solution before drying. In one embodiment, the wash solution comprises methanol. In one embodiment, the crystals are dried under a vacuum. In one embodiment, the organic scaffold comprises CNCs. In one embodiment, the cast comprises a plastic substrate. In one embodiment, a MOFCNC film is synthesized by ambient drying of a MOF and CNC mixture. In one embodiment, ambient drying occurs at a temperature of about 22° C. Drying may occur at a temperature of least about 20° C., about 20° C. to about 40° C., about 25° C. to about 35° C., or about 40° C. In some embodiments, ambient drying occurs for at least about 18 hours, about 18 hours to about 7 days, about 1 day to about 6 days, about 2 days to about 5 days, about 3 days to about 4 days, or about 7 days. In one embodiment, a PCMOF&CNC film is synthesized by ambient drying of a PCMOF and CNC mixture.

### INDUSTRIAL APPLICABILITY

The invention is further illustrated by the following non-limiting examples.

### Example 1

The physical properties of PCMOF10, and PCMOF&CNC and CNC films were characterized. XRD patterns were collected using a diffractometer with a CuKα x-ray source. Measurements were made over a range of 3°<2θ<50° with 0.02° scan width at rate of 2º min⁻¹. TGA and DSC were recorded. PCMOF10, and PCMOF&CNC and CNC film samples were placed in an aluminum pan and heated at a rate of 2° C. per min from ambient temperature to 590° C. under a N₂ atmosphere. FTIR and nuclear magnetic resonance (“NMR”) spectra were obtained for the samples. NMR spectra were obtained under 1H nuclear magnetic resonance (NMR, D₂O): δ8.20 ppm; 31P NMR: δ9.45 ppm.

The morphologies of PCMOF10, PCMOF&CNC-8/1, PCMOF&CNC-6/1, PCMOF&CNC-4/1, PCMOF&CNC-2/1, and CNC film were observed using an FE-SEM. PCMOF10 crystals display a stick-shape morphology with lengths ranging from 5 μm-40 μm and widths ranging from 100-800 nm. The PCMOF10 crystal dimensions were centuplicate larger than those of rod-shape CNC crystals, which were 100 nm-200 nm in length and 4 nm-15 nm in width. The morphology of PCMOF10 was that stacked crystalline sticks, resembling a stack of wood sticks with numerous interstices between the sticks. In contrast, the CNC film appeared uniform and compact without any micron- or submicron-sized interstices. The interstices between MOF crystals in PCMOF&CNC-8/1 and PCMOF&CNC-6/1 were filled by compact CNC aggregations compared with PCMOF10 and CNC film. The CNC aggregations appeared to act like adhesives to bond the disordered MOF crystals in the PCMOF&CNC films. More extensive and numerous CNC aggregations were observed in PCMOF&CNC-4/1 and PCMOF&CNC-2/1 compared to PCMOF&CNC-8/1 and PCMOF&CNC-6/1 because increasing the CNC content led to much larger spaces between MOF crystals in PCMOF&CNC-4/1 and PCMOF&CNC-2/1 compared to PCMOF&CNC-8/1 and PCMOF&CNC-6/1.

XRD patterns of PCMOF10, PCMOF&CNC-8/1, PCMOF&CNC-6/1, PCMOF&CNC-4/1, PCMOF&CNC-2/1, and CNC film were obtained as-synthesized and post-impedance to identify the materials and assess their thermal stability and stability under humid conditions. XRD patterns of as-synthesized PCMOF10 were in good agreement with the simulated pattern of PCMOF10. Broad reflections centered at 20=23º attributed to the identical reflection of CNC (1, 1, 0), and can be observed in the patterns of PCMOF&CNC-8/1, PCMOF&CNC-6/1, PCMOF&CNC-4/1, PCMOF&CNC-2/1 and CNC film. XRD patterns of post-impedance films were obtained by conducting impedance measurements on materials for seven weeks with operational temperatures varying from 25° C. to 85° C. and RH varying from 45% to 95%. XRD patterns of PCMOF&CNC or CNC films post-impedance showed identical reflections of pristine PCMOF10 or CNC, demonstrating the synthesized films' thermal stability and stability under humid conditions. TGA showed slight mass losses of less than 5% in the first heating step from 22° C. to 120° C., which could have been attributed to the loss of coordinated water in materials. The limited water loss indicated that the fabricated composite films had high thermal stabilities.

### Example 2

AC impedance measurements were carried out on PCMOF10, PCMOF&CNC-8/1, PCMOF&CNC-6/1, PCMOF&CNC-4/1, PCMOF&CNC-2/1, and CNC film to investigate proton conductivity. AC impedance measurements were taken at temperatures ranging from 25° C. to 85° C. and at 95% RH. Two heating and cooling cycles were performed. Nyquist plots were obtained from the second cooling cycle. The Nyquist plots indicated that PCMOF10, PCMOF&CNC-8/1 and PCMOF&CNC-6/1 displayed only tails in Nyquist plots, instead of a semicircle at high frequencies ending with a tail at low frequencies. This Nyquist plot behavior was attributed to the relatively low proton conduction resistances of PCMOF10, PCMOF&CNC-8/1 and PCMOF&CNC-6/1. Compared with PCMOF&CNC-8/1 and PCMOF&CNC-6/1, the proton conduction resistances of PCMOF&CNC-4/1 and PCMOF&CNC-2/1 increased dramatically after the weight ratio of CNC was further increased. The increased proton conduction resistances could have been attributed to huge proton transport obstruction. The huge proton transport obstruction could have in turn been caused by the extensive, numerous, and proton-insulating CNC aggregations in PCMOF&CNC-4/1 and PCMOF&CNC-2/1. This phenomenon indicates that PCMOF10 played the dominant role for proton conduction in the composite films, and that intensive and direct contacts between MOF crystals are helpful for proton conduction. Analysis of PCMOF10, PCMOF&CNC-8/1, PCMOF&CNC-6/1, PCMOF&CNC-4/1, PCMOF&CNC-2/1 and CNC film revealed proton conductivities (“σ”) with values of 4.01×10⁻², 1.44×10⁻², 7.22×10⁻³, 8.13×10⁻⁴, 4.52×10⁻⁴ and 1.87×10⁻⁴ S cm⁻¹ at 85° C. and 95% RH, respectively. All materials maintained their corresponding proton conductivities during two cycles of heating and cooling in month-long impedance measurements. Particularly, the proton conductivity of PCMOF&CNC-8/1 was the highest among the reported proton conductive MOFs and covalent organic frameworks (“COFs”) in membrane shape-bodies, including PCMOF-17 single crystal, CoLa-II single crystal, a Cu-TCPP nanosheet, MOF-801@PP, JUC-200@PVA, MOF 1-PVP, and an aza-COF-2_{H} pellet.

Impedance measurements were also conducted under different humidity conditions varying from 95% to 45% RH at 25° C. These impedance measurements showed exponential decreases of conductivities in PCMOF10 (from 2.12×10⁻² to 1.96×10⁻⁴ S cm⁻¹), PCMOF&CNC-8/1 (from 1.81×10⁻³ to 1.40×10⁻⁷ S cm⁻¹), PCMOF&CNC-6/1 (from 1.45×10⁻³ to 1.09×10⁻⁵ S cm⁻¹), PCMOF&CNC-4/1 (from 3.15×10⁻⁵ to 1.88×10⁻⁷ S cm⁻¹), PCMOF&CNC-2/1 (from 7.89×10⁻⁵ to 1.92×10⁻⁵ S cm⁻¹) and CNC film (from 1.92×10⁻⁴ to 5.31×10⁻⁸ S cm⁻¹), respectively, because water molecules are important for forming hydrogen-bond networks and achieving proton diffusion.

Arrhenius plots of PCMOF10, PCMOF&CNC-8/1, PCMOF&CNC-6/1, PCMOF&CNC-4/1, and PCMOF&CNC-2/1 at 95% RH with excellent linearities indicated that the proton conductivities of the materials were highly dependent on temperature. Generally, proton conduction involves Grotthuss (proton-hopping) and proton transport via carriers, both of which require energy contributions. Thus, the conductivity values of PCMOF10 and the PCMOF&CNC films increased with rising temperature. The proton transfer activation energies (“Eₐ”) obtained from the Arrhenius plots for PCMOF10, PCMOF&CNC-8/1, PCMOF&CNC-6/1, PCMOF&CNC-4/1, and PCMOF&CNC-2/1 were 0.13, 0.33, 0.24, 0.44, and 0.31 eV at 95% RH, respectively. These activation energies verified that proton-hopping (0.1 eV<Eₐ<0.5 eV) was the main mode of proton transport leading to the efficient conduction in PCMOF10 and PCMOF&CNC films at 95% RH.

### Example 3

Interactions between PCMOF10 and CNCs were investigated. FTIR were obtained for PCMOF10 and CNCs to explore the interactions between PCMOF10 and CNC and investigate the origin of the high mechanical strength and excellent thermal and water resistances of PCMOF&CNC composite films. FTIR were also used to investigate why CNCs have good compatibility with PCMOF10. FTIR broad bands with strong intensity near 3320 cm⁻¹, attributed to O—H stretching vibration, were observed in the spectra of PCMOF10 and CNC film. When —OH groups form intermolecular hydrogen bonds, the stretching of O—H was restricted, resulting in intensity decreasing near 3320 cm⁻¹ in the FTIR spectrum. The peak near 3320 cm⁻¹ in the PCMOF&CNC FTIR spectra was significantly and was gradually impaired when the CNC content was increased. The FTIR spectra revealed that the intermolecular hydrogen bonds were extensively built in between PCMOF10 and CNCs in their PCMOF&CNC composite films.

Forcite tools were employed to further confirm the interactions between PCMOF10 and CNCs. Analysis yielded an optimized geometry for a simulative hybrid structure consisting of a cleaved CNC surface and a cleaved PCMOF10 crystal surface. The hydrogen bonds in this simulative structure were calculated. The MOF crystal surface and CNC surface were assembled closely by abundant intermolecular hydrogen bonds (forty) with obtuse bond angles and bond lengths ranging from 1.5 to 2.6 Å. The assembly energy (“E_{assembly}”) of the MOF crystal surface and CNC surface were calculated by using Forcite tools (“E_{Forcite}”) and density functional theory (“DFT”) methods (“E_{DMol3}”). The DFT-calculated E_{DMol3} involved the energies of density of states, electron density, electrostatics, Fukui function and orbitals, and were more comprehensive and precise than E_{Forcite}. E_{Forcite} involved weak interactions of van der Waals force and electrostatics. However, the values of E_{DMol3} (−192.6 kcal mol⁻¹) and E_{Forcite} (−192.3 kcal mol⁻¹) were almost equal, suggesting that there are only weak interactions of van der Waals force and electrostatics instead of chemical bonds in between of PCMOF10 and CNCs. The typical energy of hydrogen bonds between O—H and O (O—H ⋅ ⋅ ⋅ O) are about 5 kcal mol⁻¹. Therefore, the total energy for forty of intermolecular hydrogen bonds was about 200 kcal mol⁻¹, which was consistent with the theoretically calculated E_{DMol3} and E_{Forcite}. The assembly energy measurements verified the abundant presence of intermolecular hydrogen bonds between PCMOF10 and CNCs, which provided sufficiently strong interactions for processing PCMOF10 and CNCs as mechanical, thermal and hydrolytic stable composite films.

### Example 4

PCMOF10 was synthesized for use in a PCMOF&CNC. Mg(NO₃)·2.6H₂O (206 mg, 0.82 mmol) and H₆L (326 mg, 0.96 mmol) were mixed with 6 mL methanol (MeOH) and 6 ml distilled water in a Teflon autoclave. The mixture was heated at 180° C. for 3 days, and subsequently cooled to room temperature over 18 h to obtain colorless crystals. The crystals were washed with MeOH and water several times to remove unreacted reagents, and were finally dried at room temperature under a vacuum.

### Example 5

PCMOF&CNC was synthesized. PCMOF10 and CNCs were each dispersed in water to achieve the final PCMOF:CNC ratios, i.e. 8:1, 6:1, 4:1, and 2:1. The dispersions were prepared by both sonicating and subsequent probe sonication until the suspension appeared clear with no visible aggregates. An amount of each suspension was then mixed with gentle agitation and the mixed suspension was cast as a film onto a plastic substrate. The film was allowed to form undisturbed over several days at room temperature (approximately 22° C.). Upon drying, the composite films were removed from the plastic substrate and stored for characterization.

### Example 6

Impedance measurements were conducted on PCMOF10, PCMOF&CNC and CNC films. PCMOF10, and films of PCMOF&CNC and CNC were cut into uniform size, with a 0.310 cm diameter, and then installed in custom dual-sample 2-probe cells with titanium electrodes. The cells were placed in a humidity-controlled oven for temperature and humidity controls. Impedance analysis was carried out during at least two full heating/cooling cycles. The cycles were run at temperature between 25° C. and 85° C. and were performed with more than 24 h at each temperature point.

### Example 7

Computations were performed on a MOF crystal and a CNC surface to analyze the material surface interactions. The MOF crystal surface was cleaved from a PCMOF10 unit cell, and a cellulose chain was built to represent a cleaved CNC surface. Then the cleaved MOF crystal surface and the cleaved CNC surface were built in a layered structure as a crystal. Geometry optimization was performed on the layered structure after it was formed. The energies of the cleaved CNC surface (“E_{cNc}”), the cleaved MOF crystal surface (“E_{MOF}”) and their geometric optimized hybrid structure (“E_{CNC+MOF}”) were calculated through DFT methods. In the case of DFT methods, local density approximation (“LDA”) with the PWC functions, double numeric polarization (“DNP”) basis set, and DFT semi-core Pseudopots approximation were used to calculate the energies involved density of states, electron density, electrostatics, Fukui function and orbitals. The value of the assembly energy (E_{assembly}) of the MOF crystal surface and CNC surface was calculated as the energy difference between these two surfaces before and after assembling, as defined by: E_{assembly}=E_{CNC+MOF}−(E_{CNC}+E_{MOF}).

The preceding examples can be repeated with similar success by substituting the generically or specifically described components and/or operating conditions of embodiments of the present invention for those used in the preceding examples.

Note that in the specification and claims, “about” or “approximately” means within twenty percent (20%) of the numerical amount cited.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference. Unless specifically stated as being “essential” above, none of the various components or the interrelationship thereof are essential to the operation of the invention. Rather, desirable results can be achieved by substituting various components and and/or reconfiguration of their relationships with one another.

1. A metal-organic framework film comprising:
a metal-organic framework; and
an organic scaffold;
said metal-organic framework attached to said organic scaffold by hydrogen bonds.

2. The metal-organic framework film of claim 1 further comprising a coordinated metal.

3. The metal-organic framework film of claim 2 wherein said coordinated metal comprises lanthanum.

4. The metal-organic framework film of claim 1 wherein said metal organic framework film is proton conductive.

5. The metal-organic framework film of claim 1 wherein said metal organic framework comprises [Cu₃ (BTC)·2 (H₂O)₃]ₙ.

6. The metal-organic framework film of claim 1 wherein said organic scaffold comprises a cellulose material.

7. The metal-organic framework film of claim 1 wherein said organic scaffold comprises a cellulose nanocrystal.

8. The metal-organic framework film of claim 1 wherein said organic scaffold comprises a cellulose nanofibril.

9. The metal-organic framework film of claim 1 wherein said organic scaffold comprises chitosan.

10. The metal-organic framework film of claim 1 wherein said organic scaffold comprises alginate.

11. The metal-organic framework film of claim 1 wherein said organic scaffold comprises hyaluronic acid.

12. The metal-organic framework film of claim 1 wherein a ratio of said metal-organic framework and said organic scaffold is about 10:1.

13. The metal-organic framework film of claim 1 wherein a ratio of said metal-organic framework and said organic scaffold is about 8:1.

14. The metal-organic framework film of claim 1 wherein a ratio of said metal-organic framework and said organic scaffold is about 6:1.

15. The metal-organic framework film of claim 1 wherein a ratio of said metal-organic framework and said organic scaffold is about 4:1.

16. The metal-organic framework film of claim 1 wherein a ratio of said metal-organic framework and said organic scaffold is about 2:1

17. A method of making a metal-organic framework film, the method comprising:
contacting a metal with a hydrogen lattice to form a mixture;
heating the mixture under pressure;
cooling the mixture to produce crystals;
contacting the mixture with an organic scaffold to form a crystal and organic scaffold mixture;
at least partially disposing the crystal and organic scaffold mixture into a cast; and
drying the crystal and organic scaffold mixture.

18. The method of claim 17 wherein the mixture is cooled at ambient temperature.

19. The method of claim 17 wherein the organic scaffold comprises cellulose nanocrystals.

20. The method of claim 17 wherein the metal comprises magnesium.
